(19) United States
(12) Patent Application Publication
(10) Pub. No.: US 2026/0289490 A1
(43) Pub. Date: Sep. 24, 2026

(54) METHOD FOR DETERMINING A PLAN FOR ARRANGING CONTENTS IN A CONTAINER

(71) Applicant: ITINSELL X, Lyon (FR)

(72) Inventors: Manel CHARFI, Caluire-et-Cuire (FR); Julien FIETTE, Villeurbanne (FR); Yannick FRANCOIS, Chazay D'Azergues (FR)

(21) Appl. No.: 19/124,034

(22) PCT Filed: Oct. 27, 2023
(86) PCT No.: PCT/EP2023/080119

§ 371 Date: Apr. 24, 2025

(30) Foreign Application Priority Data
Oct. 27, 2022 (FR) FR2211234
Oct. 27, 2022 (FR) FR2211235
Oct. 27, 2022 (FR) FR2211236
Oct. 27, 2022 (FR) FR2211237

(51) Int. Cl. G06Q 10/083

(52) U.S. Cl. CPC G06Q 10/0843

(57) ABSTRACT

A method for determining an arrangement plan for arranging several contents in a container, implemented by computer and including steps of: prior to the virtual arrangement, determining the maximum dimensions of the container according to dimensions of the contents; virtually arranging a first content at a predetermined position of the container; and in order to virtually arrange one of the remaining contents: determining the dimensions and coordinates of several remaining empty spaces of the container, separate from each other and having respective shapes of a rectangular cuboid; determining possible positions of the remaining content in each empty space; determining respective distances between a top of the container and the tops of the remaining content in each possible position; depending on the distances, selecting one of the possible positions as virtual arrangement of the remaining content; repeating the previous arrangement steps successively for each of the other contents.

### FIELD OF THE INVENTION

The invention relates to the field of parcel delivery, in particular the arrangement of various contents in a container for their storage and transport.

### BACKGROUND

In the state of the art, in a warehouse, the order preparer has firstly contents, the products, intended to be grouped together in a container forming a logistic unit load. This “logistic unit load” is generally called a “parce” when it is associated with a delivery in progress or completed. Secondly, the order preparer has packages used to pack these logistic unit loads to be shipped. The choice of package for each logistic unit load is generally made visually by the order preparer according to their estimation of the volume of the products forming the logistic unit load and their estimation of the volume of the package. The choice can also be standardised on automated lines, the logistic unit loads then being positioned in packages of similar or even identical dimensions. In addition, the choice of arranging the products in the package, in other words the positioning of each product in the package, is made without external assistance, instinctively and on the basis of practical experience. Similarly, subsequently, the logistician has firstly the packed logistic unit loads to be grouped together, and secondly the aggregative logistic unit loads, such as pallets, containers and lorries, used to contain these packed logistic unit loads for their storage and delivery. Once again, steps of arranging the packed logistic unit loads are required to arrange them within the aggregative logistic unit loads.

Thus, generally, the players in the field of delivery arrange contents of different dimensions in a container to be chosen among several different types of container, in order to store and deliver the contents.

However, due to insufficient time and the few different types of container, many arrangements are not optimum. Poorly arranged, the overall volume taken up by the contents is too large, generating too much storage space. Similarly, due to the poor arrangement of the contents, the containers integrating these contents, which are too voluminous, have a high void rate. Thus, in the case of logistic unit loads to be packed, numerous logistic unit loads shipped are formed from products that are poorly arranged together, in an unsuitable package. The average void rate thus generated results in overconsumption of packages and therefore a significant waste of material, associated greenhouse gas emissions, as well as major financial losses for the players in the field of delivery. This average void rate also results in overconsumption of storage spaces, particularly in the relay points, this saturation of storage space possibly in turn increasing the distance between the home of the parcel recipient and the relay point, if the parcel has to be reassigned to a remote relay point. Too much empty space in a package also generates risks of breakage and therefore of additional trips. In addition, products arranged in a package that is too large require additional chocking, which further increases the waste of raw material. Lastly, unsuitable packages also make the handling of these logistic unit loads more difficult.

The problem of overconsumption of space, and its implications in terms of damage to the environment, also applies to the arrangement of logistic unit loads in a pallet, in a container or in a lorry, as well as to the arrangement of pallets in a lorry.

The state of the art already describes the manufacture, by robot, in a warehouse, of made-to-measure packages, adapted to the dimensions and fragility type of each logistic unit load. However, this solution, in addition to preventing the reuse of reusable or circular economy packages, being expensive and complicated to implement, does not provide any solution for the order preparer to quickly find the most optimum arrangement possible of products in the package. In addition, it cannot be generalised to all types of content and container. Lastly, it is limited in terms of processing capacity per hour, and therefore unsuitable for the management of variations in seasonal volume.

### SUMMARY

The invention aims in particular to provide a solution for optimising the arrangement of contents intended for a container.

Thus, the invention relates to a method for determining an arrangement plan for arranging several contents in a container, the contents and the container having respective virtual shapes of a rectangular cuboid, the method being implemented by a computer and comprising the following steps:
prior to a virtual arrangement, determining the maximum dimensions of the container according to the dimensions of the contents to be arranged;
among the contents to be arranged in the container, virtually arranging a first content at a predetermined position of the container;
in order to virtually arrange one of the remaining contents in the container:
   determining the dimensions and coordinates of several remaining empty spaces of the container, separate from each other and having respective virtual shapes of a rectangular cuboid;
   determining possible positions of the remaining content in each empty space;
   determining respective distances between a predetermined top of the container and respective tops of the remaining content in each possible position;
   depending on the distances determined, selecting one of the possible positions as virtual arrangement of the remaining content in the container;
   repeating the preceding arranging steps successively for each of the other remaining contents to be virtually arranged in the container, in order to determine an arrangement plan for arranging all the contents in the container.

Thus, the container and the contents, as well as the empty spaces, are defined in the form of data structures processed by computer. Consequently, by arranging each virtual content, in turn, in the position farthest away from a given point of the container, after identifying the empty spaces available, it appears that on average the position of these contents is significantly optimised so that the final arrangement of all these contents occupies the smallest possible volume. Determining the maximum dimensions of the container beforehand, depending on dimensions of the contents, makes it possible to delimit a first bounded space within which the virtual arrangement steps are then implemented. Finally, creating beforehand this bounded space, which depends on the dimensions of the contents, reduces the final void rate of the container in which the contents are virtually arranged. It is then possible to choose to assign a real container whose dimensions are adapted to the arrangement determined, or conversely, to first choose a real container for which the arrangement of the contents is to be determined.

Implementing these steps on computer provides an arrangement solution to the logistician or the order preparer, who now simply has to apply it to the real contents and containers available. In addition to “computer”, we will also speak of “computer means” and for convenience of “means”.

Other optional characteristics taken alone or in combination are given below.

Advantageously, the method further comprises a step of determining the coordinates of each of the contents arranged virtually in the container, the determined arrangement plan indicating these coordinates.

Thus, the plan contains the coordinates of each of the contents, so that a user to whom the plan is provided can perform the actual arrangement of real contents corresponding to the virtual contents according to the arrangement plan determined, using the indications of the plan. The user does not have to search for the best possible position of each content themselves, they save time while optimising the arrangement. In this case for example, the coordinates are provided to software external to the method, whose purpose is to represent the arrangement determined to the user. The coordinates can also be provided to automated means which themselves carry out the actual arrangement according to the plan.

Preferably, each content and each container having a first dimension, a second dimension orthogonal to the first dimension and a third dimension orthogonal to the first and second dimensions, the step of determining the maximum dimensions of the container is implemented as follows:
identifying the most voluminous content among the contents to be arranged in the container;
determining a value to be added corresponding to the sum of the maximum dimensions of each content except the most voluminous content;
determining a first maximum dimension of the container corresponding to the sum of a first dimension of the most voluminous content and the value to be added;
determining a second maximum dimension of the container corresponding to the sum of a second dimension of the most voluminous content and the value to be added;
determining a third maximum dimension of the container corresponding to the sum of a third dimension of the most voluminous content and the value to be added.

Thus, during this preliminary step, the means determine a first bounded space in which the virtual arrangement is determined. In other words, this space defines the dimensions of a first fictitious container in which the virtual contents are arranged one after the other. This restricts the next steps of the method, in particular when looking for empty spaces. At the end of the steps, the minimum dimensions of the container determined for the arrangement will necessarily at best be as large as this first bounded space, and generally smaller. This first space is defined from the most voluminous virtual content and by adding in its three dimensions the maximum dimensions of each other content. This therefore guarantees that the arrangement of the contents juxtaposed with each other is located in this maximum space.

Advantageously, the contents correspond to products forming a single logistic unit load and the container corresponds to a package used to pack this logistic unit load.

Thus, the method is applied to the package of the logistic unit loads, in a warehouse. The method allows an order preparer to obtain at least indications concerning an optimum arrangement of the products forming the logistic unit load, in particular the minimum dimensions of a package, which allows the order preparer to choose an optimum package from the real packages available, rather than estimating the adequate volumes visually. As a result, the average void generated in the packages of the logistic unit loads and the order preparation time are reduced.

Alternatively, the contents correspond to packages already prepared and the container corresponds to a pallet, a container or a lorry, or the contents correspond to pallets and the container corresponds to a container or a lorry.

Thus, the method is applied to other scales of the supply chain, in other words to the arrangement of packages in a pallet, a container or a lorry, or to the arrangement of pallets in a container or a lorry. The problem is in fact similar to that of arranging products in a package, and the desired objective, to reduce the void rate and its consequences in the field of parcel delivery, is the same.

Preferably, the determined arrangement plan also indicates orientations of the contents in the container, these orientations being determined as follows:
for the contents still to be arranged:
   the step of determining the possible positions of the content is implemented, in at least one of the empty spaces, for at least two of the possible orientations of the content in the empty space,
   the distance separating the top of the container from the tops of the possible positions is determined for these possible orientations, so that selecting the position as a virtual arrangement of the content includes selecting the orientation of this content;
for the first content to be placed, at a predetermined position of the container:
   determining the possible ways of positioning the content at this position for at least two of the possible orientations of the content,
   determining distances separating the predetermined top of the container from the tops of the possible positions of the content for these possible orientations,
   selecting the orientation of the content according to the distances determined.

Thus, the means take into account the possible orientations of the virtual contents to be arranged, in order to identify the combination of the position and orientation of the content in order to obtain the most compact arrangement possible. This further optimises the arrangement of the contents in the container. The number of orientations tested, or even the choice of these orientations to be tested, can be configured beforehand, for example by a user of the method.

Advantageously, the method comprises, beforehand, a step of sorting the virtual contents to be arranged by decreasing volume, so that the first virtually placed content has the largest volume among all the virtual contents to be arranged and the contents still to be virtually arranged are arranged successively:
according to the sorting, or
according to a characteristic associated with each content different from the volume, such as weight, fragility, radioactivity level, perishability, or
according to a value resulting from a combination of the volume of the contents and one or more characteristics among the characteristics different from the volume.

Thus, by taking into account only the volume, this sorting is a way of choosing the order of the virtual contents to be arranged that, on average, is more relevant, in terms of the void rate, than a randomly chosen order. Alternatively, by taking into account other characteristics, the method is directed towards an arrangement that may be more relevant with regard to the contents to be arranged, for example by placing a fragile content last or a heavy content first.

Preferably, the method comprises the following steps:
first, assigning a respective random key to each content to be arranged, the keys determining the order in which the contents are to be arranged;
determining an arrangement plan for arranging the contents according to the method described above, in the determined order;
for these same contents, implementing at least one repetition of the steps of assigning keys and determining an arrangement plan, in order to obtain several possible arrangement plans for arranging the contents in the container, each possible arrangement being different from at least some of the other possible arrangements in that the order of the contents virtually arranged in the container is different, these several possible arrangements forming an initial generation of arrangements;
determining a void rate for each arrangement of the initial generation,
selecting a predetermined number of arrangements of the initial generation having a void rate lower than that of other arrangements of the same generation;
crossing over the selected arrangements of the initial generation, the crossover being performed according to the random keys, so as to produce arrangements of a next generation resulting from this crossover;
repeating the steps of determining the void rate, of selecting and of crossing over, at least for this next generation, until a predetermined number of generations is reached;
selecting the arrangement, among all the arrangements of all the generations, having the lowest void rate, to determine the arrangement plan for arranging the contents in the container.

Thus, the means execute a biased random-key genetic algorithm, in which the genetic sequences correspond to sequences of contents to be arranged in a determined order. For each sequence, the arrangement plan is determined according to the steps previously described, in other words looking for available empty space and comparing distances. Thanks to the selection and crossover steps performed on these sequences, this method can be used to explore a multitude of possible arrangement sequences, in other words a multitude of possible orders for the contents to be arranged. By testing sequences resulting from sequences that are themselves considered to be relevant, thanks to the selection of parent sequences on the basis of the void rates, the algorithm tends, generation after generation, towards the identification of sequences forming the most compact arrangements possible.

Preferably, for each generation, before the steps of determining the void rate for each arrangement, the method comprises steps of checking the adequacy of each arrangement with respect to at least one predetermined criterion, for example relating to the weight, fragility, perishability or radioactivity level of the contents of the arrangement, the steps of determining the void rate being performed only for the arrangements checked as being adequate, it being no longer possible to select the other arrangements.

Thus, the compaction of each arrangement is taken into account only after one or more other criteria have been considered. It is therefore possible to take into account other criteria in addition to that of the void rate. For example, it may be relevant that only arrangements in which the fragile contents are located above less fragile contents are taken into consideration.

Advantageously, the method comprises the following steps:
implementing the steps described previously to determine an initial arrangement plan for arranging the contents;
determining a first minimum volume of a first container of the first arrangement plan;
determining a second minimum volume of a second container of a second arrangement plan for the same contents as follows:
   each content and each container having a first dimension, a second dimension orthogonal to the first dimension and a third dimension orthogonal to the first and second dimensions, the first dimension of the second container corresponds to the sum of the first dimensions of each content, the second dimension of this second container corresponds to the largest dimension among the second dimensions of the contents, and the third dimension of this second container corresponds to the largest dimension among the third dimensions of the contents;
   determining the minimum volume of the second container on the basis of the determined dimensions of the second container;
determining the arrangement plan, among the first and second arrangement plans, whose container has the smallest minimum volume.

Thus, the means determine, for the contents to be arranged, a first container according to the steps already described, in other words at least with the search for empty spaces, or even with the repetition of these searches according to several sequences according to the genetic algorithm described. This first approach leads to the minimum dimensions of a first container. In parallel, before or after, the means perform a second approach, which consists in adding the first respective dimensions of the contents to determine a first dimension of the second container and in choosing the largest second and third dimensions among the contents to form the second and third dimensions of the second container. This second approach generally leads to a second container that is more voluminous than the first container resulting from the first approach, but the opposite could occur. Comparing the result of the first approach, which is generally optimum, but costly in terms of calculation and therefore longer, with that of the second approach, which is faster, guarantees even better optimisation in the search for the smallest container, and therefore the most compact arrangement, for a minor additional computing effort.

Preferably, the method comprises, once all the contents have been virtually arranged in the container, a step of determining the minimum dimensions of the container including all the virtually arranged contents, the arrangement plan indicating these minimum dimensions.

Advantageously, once the arrangement plan has been determined, a real container is chosen whose dimensions are greater than or equal to the minimum dimensions of the container of the determined arrangement plan, and the real contents are arranged in the real container according to the arrangement plan.

Thus, the user, such as the logistician or the order preparer, performs the arrangement according to the arrangement plan resulting from the method. The user then generates void rates that are on average lower than if an empirical or intuitive method had been used.

Preferably, the method comprises the following steps:
providing the dimensions of the container in which the contents are to be virtually arranged;
implementing the steps of the genetic algorithm that have been described above for this container, in order to determine the arrangement plan for arranging the contents in this container.

Thus, in this case, the dimensions of a package are first provided to the computer means, so that they can determine the arrangement plan for arranging the contents for this package. The arrangement can therefore be restricted to the packages that are actually available.

Advantageously, the method further comprises the following steps:
the container being a first container, determining the void rate of the first container comprising the virtually arranged contents;
providing the dimensions of a second container in which the same contents are to be virtually arranged;
implementing the steps of the genetic algorithm described above for this second container and for the same contents to be arranged in this second container, in order to determine a second arrangement plan for arranging the contents in this second container;
determining the void rate of the second container comprising the virtually arranged contents;
choosing the container, among the first and second containers, having the lower void rate, the arrangement plan indicating the container selected;
arranging real contents in a real container chosen according to the arrangement plan.

Thus, the means implement the genetic algorithm described above successively for several different containers, in which they test the arrangement of the same virtual contents, in order to identify the most adequate container for these contents. In particular, in this case the means do not determine a first bounded empty space, in other words the maximum dimensions of the container, since the dimensions of the container to be tested are provided as input. Lastly, the means identify the arrangement plan, among all those tested, which provides the lowest possible void rate for these containers.

If other criteria, such as for example the weight, fragility, radioactivity, perishability, associated with the contents, have been taken into account in the genetic algorithms applied to each of the containers, the means therefore identify the arrangement plan which provides the lowest void rate among the arrangements respecting the required criteria.

The invention also provides for a method for assigning a package to a logistic unit load, implemented by computer and comprising the following steps:
selecting available packages;
for each package selected, determining a prioritisation value for the package, the value depending at least on the volume of the package so that a package that is less voluminous than another one takes priority, all other things being equal, over this other package;
sorting the packages according to their respective prioritisation values in order to form a sorted list of the packages;
choosing one of the packages from the sorted list;
checking the adequacy between the chosen package and a logistic unit load to be packed, the check concerning at least the weight of the logistic unit load with respect to a maximum weight supported by the package;
determining, according to the method described above, an arrangement plan for arranging several virtual contents forming the logistic unit load in the package.

The invention also provides for a method for preparing a logistic unit load to be packed, comprising the steps of:
storing products in a product picking space, the space including product locations, each product location being associated with an identifier;
storing packages in a package picking space, the space including package locations, each package location being associated with an identifier;
obtaining a selection of products, the selected products forming a logistic unit load to be packed;
obtaining a selection of a package;
obtaining a route for collecting the selected products and the selected package in the picking spaces, the route comprising the identifiers of the locations of the selected products and package to be collected;
collecting the selected products and the selected package in the picking spaces according to the route and the selections;
in a space for preparing a logistic unit load to be packed, arranging, according to an arrangement plan determined according to a method described above, the selected products in the selected package, in order to form the packed logistic unit load.

The invention also provides for a computer program comprising instructions which, when the program is executed by a computer, instruct the computer to implement the steps of any one of the methods described above.

The invention also provides for a computer-readable storage medium comprising instructions which, when they are executed by a computer, instruct the computer to implement the steps of any one of the methods described above.

The invention also provides for a method for assigning a package to a logistic unit load, implemented by a computer and comprising the following steps:
selecting available packages;
for each package selected, determining a prioritisation value for the package, the value depending at least on the volume of the package so that a package that is less voluminous than another one takes priority, all other things being equal, over this other package;
sorting the packages according to their respective prioritisation values in order to form a sorted list of the packages;
choosing one of the packages from the list according to the sorting;
checking the adequacy between the chosen package and a logistic unit load to be packed, the check concerning at least the weight of the logistic unit load with respect to a maximum weight supported by the package.

Thus, the order preparer has numerous different package references, in particular with different dimensions, since these packages are selected and sorted automatically by computer ready for an assignment adapted to the logistic unit load, without the preparer having to estimate the corresponding dimensions visually. Increasing the number of possible packages available to the preparer increases the probability that each logistic unit load to be packed is associated with an adequate package.

Sorting the packages according to a value determined at least by the volume of these packages, and therefore choosing the smallest package possible for the logistic unit load to be packed, guarantees that a package having an optimised void rate will be chosen.

Checking the adequacy of the package with the logistic unit load at least as regards the weight criterion ensures that the package is physically capable of containing the logistic unit load and, in particular, simplifies the handling of these units.

By proceeding in this way for each logistic unit load, each one is quickly assigned a suitable respective package, while reducing the average void rate of the packed logistic unit loads, thereby removing the disadvantages mentioned above.

In addition to “computer”, we will also speak of “computer means” and for convenience of “means”.

Other optional characteristics taken alone or in combination are given below.

Advantageously, the method further comprises a step, if the adequacy is invalidated, of choosing a package according to the sorted list, and a step of checking the adequacy of this next package with the logistic unit load, these steps being repeated until:
a package from the list is confirmed as being adequate, the adequate package being in this case assigned to the logistic unit load;
a predetermined number of steps of checking the adequacy has been reached; or
the end of the package list has been reached.

Thus, the computer means repeat the steps of the method for each package on the sorted list, in other words by always choosing the package with the highest priority among the packages still on the list.

Preferably, if no package on the list is considered to be adequate, the method comprises a step of manufacturing, preferably by robot, a package corresponding to the dimensions of the logistic unit load.

Thus, if no appropriate package is identified, the method proposes to a user the made-to-measure manufacture of a package. This made-to-measure manufacture can be manual or use a robot. Thus, the dimensions of the package to be manufactured can be provided to a manufacturer or to a robot.

Advantageously, the prioritisation value further depends on a durability characteristic of the package.

A “durability”, or “sustainability” criterion, or characteristic, is a criterion relating to waste reduction, the renewable nature of the package, or, as a non-exhaustive example, relating to the circular economy applied to the packages of the logistic unit loads. Thus, if the package promotes the circular economy, in particular if it can be used or has already been used for other logistic unit loads, it is considered to be more durable than another single-use package, for example. This is also the case for a package made of materials considered to be more “durable” than those of another.

Preferably, for each package, the prioritisation value is determined as follows:
first, associating a durability coefficient to the package, the coefficient depending on a durability characteristic of the package;
multiplying the package volume by the durability coefficient to obtain the package prioritisation value.

Thus, to associate the durability with the real volume of the package, the means determine a value corresponding to a “fictitious volume” of the package, in other words a volume to which a coefficient has been assigned that can modify the subsequent sorting of the packages. In particular, for the same volume, a package that is more durable than another will be assigned a smaller fictitious volume using a durability coefficient assigned for this purpose.

Advantageously, the prioritisation value further depends on at least one other predetermined characteristic, such as a price of the package, a quantity of greenhouse gas emission or a quantity of material of the package.

Thus, one or more variables can be associated with the package volume in order to sort the packages. The criteria can be chosen by a user of the method, such as a logistician or a shipper of the logistic unit load.

Preferably, the prioritisation value is determined as follows:
normalising the volume values and the values of the other characteristics of all the packages selected so that they can be compared;
for each package, adding the normalised values, each of these values being multiplied by a predetermined weighting factor, in order to obtain the package prioritisation value.

Thus, to compare values associated with widely different criteria, such as a price, a volume and a quantity of material, the means normalise these values, in particular by taking into account the maximum and minimum values of each of these variables for all the packages to be sorted.

Advantageously, the adequacy check further concerns a void rate of the package in which the logistic unit load will be packed, or an average void rate of packages in which a series of respective logistic unit loads would be packed.

Thus, in the first case the means determine a void rate, by comparing the package volume with the total volume of the products forming the logistic unit load and, if this rate is below the threshold, the package is considered to be adequate. This threshold can be determined by a user of the method such a logistician or a shipper of the logistic unit load. This ensures that each logistic unit load and its package respect the void rate set. In the second case, the means determine this void rate for a series of logistic unit loads assigned to their respective packages, in particular over a series of units whose adequacy with the logistic unit load to be processed has been confirmed previously, and confirm the adequacy of this logistic unit load if, on average, the void rate of the series is below a predetermined threshold. Consequently, some logistic unit loads and their respective packages will not respect the void rate set, but will nevertheless be confirmed if they follow a series of units assigned to packages which, on average, respect a void rate. In this second case, it is therefore accepted that some proposals include a greater void if, on average, the objective is respected.

Preferably, the check further concerns at least the presence of a part of the logistic unit load classified as fragile with respect to a package classified as being adapted for packing a fragile content, and/or the arrangement of the contents forming the logistic unit load with respect to an arrangement to be respected regarding the fragility of the logistic unit load.

Thus, the means also take into account the fragility of the unit, as it is recorded in databases, to check that the package is adequate for the unit.

Advantageously, the selection includes only the packages having dimensions greater than or equal to the dimensions of the logistic unit load to be packed, or the adequacy check further concerns the dimensions of the package with respect to the dimensions of the logistic unit load to be packed.

Thus, whether before or at the latest during the method, the means select only the packages which are physically capable of containing the contents, and eliminate the others, in order to accelerate the other steps and avoid choosing a package that would have inappropriate dimensions.

Advantageously, the method comprises, after the step of choosing a package from the list and before the step of checking the adequacy, a step of adding a margin to the package dimensions, the margin being previously associated with at least one product forming the logistic unit load or with the package.

Thus, a user may have previously associated a margin with a specific product, a specific package or a global margin concerning all the packages. This margin is taken into account when checking the adequacy between the logistic unit load and the package.

Preferably, the method comprises, beforehand, a step of determining the dimensions of the logistic unit load to be packed.

Thus, the means first determine the dimensions of the logistic unit load to be packed, before performing the next steps.

Advantageously, the method further comprises a step of determining an arrangement plan for arranging several contents forming the logistic unit load in a virtual container or in the chosen package.

Thus, the means identify how the products forming the logistic unit load must be arranged to make the logistic unit load as compact as possible, in order to reduce the void rate, and then in order to choose the smallest possible package and therefore reduce the storage volume occupied.

Preferably, the dimensions of the logistic unit load and/or the arrangement plan are determined as follows, the logistic unit load consisting of several contents to be arranged in a container:
the contents and the container having respective virtual shapes of a rectangular cuboid, among the contents to be arranged in the container, virtually arranging a first content at a predetermined position of the container;
in order to virtually arrange one of the remaining contents in the container:
   determining the dimensions and coordinates of several remaining empty spaces of the container, separate from each other and having respective shapes of a rectangular cuboid;
   determining possible positions of the remaining content in each empty space;
   determining respective distances between a predetermined top of the container and the respective tops of the remaining content in each possible position;
   depending on the distances determined, selecting one of the possible positions as virtual arrangement of the remaining content in the container;
repeating the previous arrangement steps for successively each of the other contents still to be virtually arranged in the container;
when all the contents have been virtually arranged in the container, determining as described previously the minimum dimensions of the container including all the virtually arranged contents and/or providing as described previously determined the virtual arrangement.

Thus, the container and the contents, as well as the empty spaces, are defined in the form of data structures processed by computer. Consequently, by arranging each content, in turn, in the position farthest away from a given point of the container, after identifying the empty spaces available, it appears that on average the position of these contents is significantly optimised so that the final arrangement of all these contents occupies the smallest possible volume. The assigned package is then given dimensions adapted to the arrangement determined, or conversely using these steps, a real package for which the arrangement of contents is to be determined is tested. In both cases, determining in an optimised manner the arrangement of the contents so that they are as compact as possible reduces the average void rate of the packed logistic unit loads. In addition, by implementing these steps on computer it is possible to provide an arrangement solution to the logistician or the order preparer, who now simply has to apply it to the real logistic unit loads and packages available.

Advantageously, the method further comprises the following steps:
determining a void rate for the package and the logistic unit load associated with the determined arrangement plan;
for each package still on the sorted list, repeating the steps of determining the arrangement plan as described previously and determining the void rate;
assigning the package associated with the lowest void rate to the logistic unit load.

Thus, the means determine the plans for arranging the contents associated with several possible packages, and they eventually assign to the logistic unit load the package for which the arrangement plan provides the smallest void rate. This embodiment can be chosen by users who want to optimise the choice of package, in terms of void rate, as relevantly as possible. These characteristics can in fact be used to test several packages, even if some, a priori, according to the sorted list of packages, have lower priority than others, and to only keep that having the lowest void rate among these packages.

Preferably, the method comprises, beforehand, the following steps, to group contents in a logistic unit load:
scanning a list of planned shipments, each shipment planning a delivery of one or more contents, and, for each shipment on the list, creating exclusive logistic unit loads for the shipment contents intended for exclusive packages, and creating logistic unit loads intended to group the other contents of the shipment not intended for exclusive packages;
determining, for each logistic unit load created, a package type, based on package types for which the contents of the logistic unit load are intended, the package types being different from each other in terms of their material, general shape or robustness;
assigning during the sorting step previously described packages corresponding to the determined package type.

Thus, beforehand, the means group the contents to be shipped in logistic unit loads adapted to these contents. They may also identify a particular package type on which the steps already described of assigning the package must be based.

Advantageously, the method further comprises a step of positioning the products forming the logistic unit load in the chosen package.

Thus, the user, such as an order preparer or a logistician, carries out the real positioning of the products forming the logistic unit load in the package identified by the means using the steps described. This positioning can also be carried out by automated means.

The invention also provides for a method for preparing a logistic unit load to be packed, comprising the steps of:
storing products in a product picking space, the space including product locations, each product location being associated with an identifier;
storing packages in a package picking space, the space including package locations, each package location being associated with an identifier;
obtaining a selection of products, the selected products forming a logistic unit load to be packed;
obtaining a selection of a package according to the assignment method as described previously;
obtaining a route for collecting the selected products and the selected package in the picking spaces, the route comprising the identifiers of the locations of the selected products and of the package to be collected;
collecting the selected products and the selected package in the picking spaces according to the route and the selections;
in a space for preparing a logistic unit load to be packed, arranging the selected products in the selected package, in order to form the packed logistic unit load.

The invention also provides for a computer program comprising instructions which, when the program is executed by a computer, instruct the computer to implement the steps of one of the methods described above.

The invention also provides for a computer-readable storage medium comprising instructions which, when they are executed by a computer, instruct the computer to implement the steps of one of the methods described above.

The invention also provides for a method for preparing a logistic unit load to be packed, comprising the steps of:
storing products in a product picking space, the space including product locations, each product location being associated with an identifier;
storing packages in a package picking space, the space including package locations, each package location being associated with an identifier;
obtaining a selection of products, the selected products forming a logistic unit load to be packed;
obtaining a selection of a package;
obtaining a route for collecting the selected products and the selected package in the picking spaces, the route comprising the identifiers of the locations of the selected products and package to be collected;
collecting the selected products and the selected package in the picking spaces according to the route and the selections;
in a space for preparing a logistic unit load to be packed, arranging the selected products in the selected package, in order to form the packed logistic unit load.

Thus, the package is now considered as a product. In fact, the package is stored, like the products, in a picking space, including, as for a product, identified locations. As for the products, it undergoes a collection step. It is therefore no longer chosen from the few packages available in the restricted preparation space, but from all the packages in the package picking space, the latter being as large as necessary like the product picking space.

Thus, the order preparer is no longer restricted by the few packages available in their preparation space, they can use all the packages in a package picking space, all the packages in a package picking space being available, in the same way as all the products in the product picking space. The order preparer can therefore use, for each logistic unit load, a large number of different packages, in particular of different types and dimensions, and can therefore pack each logistic unit load with the most appropriate package among this large number of packages. The average void rate of a logistic unit load can therefore be reduced.

Adding the step of collecting the package in a package picking space adds a step likely to lose time and therefore productivity at this particular point. However, the productivity lost by the step of collecting the package is offset by the choice of a route allowing the package to be picked at the same time as the product, the package being considered to be an extra product of the order to be collected. It is also offset by the fact that there is no need to regularly go and get packages in bulk package mass storage spaces to take them near to the preparation space or to add additional chocks.

The route can include a product collection route and a separate package collection route. This is particularly appropriate if the product picking spaces and the package picking spaces are far from each other.

In the remainder of this document, in addition to “computer”, we will also speak of “computer means” and for convenience of “means”.

Other optional characteristics taken alone or in combination are described below.

Advantageously, to obtain the route, a computer determines a route optimised according to the locations of the products and the location of the package so that the collection of the products and the package is as fast as possible.

Thus, the collection is as fast as possible, the package simply being an extra object, in addition to the products, to be collected.

Preferably, the package is selected according to the following steps, implemented by computer:
selecting packages available in the package picking space;
for each package selected, determining a prioritisation value for the package, the value depending at least on the volume of the package so that a package that is less voluminous than another one takes priority, all other things being equal, over this other package;
sorting the packages according to their respective prioritisation values in order to form a sorted list of the packages;
choosing one of the packages from the list according to the sorting;
checking the adequacy between the chosen package and the logistic unit load to be packed, the check concerning at least the weight of the logistic unit load with respect to a maximum weight supported by the package.

Thus, a package adapted to the dimensions of the logistic unit load is assigned so that the void of each logistic unit load packed is as small as possible. The result is an average void rate that is much smaller.

Advantageously, each product selected corresponding to a content and the package selected corresponding to a container, the contents and the container selected having respective shapes of a rectangular cuboid, the selected products are arranged in the selected package according to an arrangement plan, the arrangement plan being determined according to the following steps, implemented by computer:
among the contents to be arranged in the container, virtually arranging a first content at a predetermined position of the container;
in order to virtually arrange one of the remaining contents in the container:
   determining the dimensions and coordinates of several remaining empty spaces of the container, separate from each other and having respective shapes of a rectangular cuboid;
   determining possible positions of the remaining content in each empty space;
   determining respective distances between a predetermined top of the container and the respective tops of the remaining content in each possible position;
   depending on the distances determined, selecting one of the possible positions as virtual arrangement of the remaining content in the container;
   repeating the previous arrangement steps for successively each of the other contents still to be virtually arranged in the container, in order to determine an arrangement plan for arranging all the contents in the container.

Thus, the container and the virtual contents, as well as the empty spaces, are defined in the form of data structures processed by computer. Consequently, by arranging each content, in turn, in the position farthest away from a given point of the container, after identifying the empty spaces available, it appears that on average the position of these contents is significantly optimised so that the final arrangement of all these contents occupies the smallest possible volume.

Preferably, packages selected according to logistic unit loads are stored in the package picking space, according to the following steps, implemented by computer:
obtaining a list of packages;
for each of the packages on the list obtained, determining a prioritisation value for the package, the value depending at least on the volume of the package so that a package that is less voluminous than another one takes priority, all other things being equal, over this other package;
sorting the packages according to their respective prioritisation values in order to form a sorted list of the packages;
choosing one of the packages from the list according to the sorting;
obtaining a list of logistic unit loads, each logistic unit load on the list having dimensions that are smaller than those of the chosen package;
for each logistic unit load on the list, checking the adequacy between the chosen package and the logistic unit load, the check concerning at least the weight of the logistic unit load with respect to a maximum weight supported by the package;
if the number of logistic unit loads checked as being adequate for the chosen package is greater than or equal to a predetermined threshold, selecting the package for storage in the package picking space, and removing, from the list of logistic unit loads, the logistic unit loads checked as being adequate for this selected package.

Thus, the packages stored in the package picking space are selected beforehand in order to be chosen to be stored. They are appropriate for the logistic unit loads shipped in the past or for logistic unit loads, or products, never shipped but to be tested for possible future shipments. Consequently, they will probably be suitable for the logistic unit loads shipped in the future by the same logistician.

Advantageously, the logistic unit load being a first logistic unit load, preparing a second logistic unit load to be packed comprising the steps of:
obtaining a second selection of products, the selected products forming the second logistic unit load to be packed;
obtaining a selection of a second package;
in the step of obtaining the collection route, the products include the selected products forming the first logistic unit load and the selected products forming the second logistic unit load, as well as the two respective packages selected, the route comprising the identifiers of the locations of the selected products and packages to be collected of the first and second logistic unit loads;
in the collection step, the selected products and packages of the first and second logistic unit loads are collected;
in the preparation space, or in this space and another preparation space, the two packed logistic unit loads are formed.

Thus, the route for at least two orders is obtained, and an optimised collection step is performed to allow optimum collection of the products and the packages corresponding to these orders.

What is applied to two logistic unit loads can be applied to more. A number n of logistic unit loads can therefore be prepared in this way, n being greater than 2, by obtaining n selections of corresponding products, by selecting n corresponding packages, by obtaining an optimised collection route for the n products and the n packages, by collecting them, and by preparing the n logistic unit loads in the preparation space. The preparation of n orders is thus optimised.

Firstly, the selected products of these logistic unit loads can be collected, according to an optimised route of the products, and secondly the selected packages of the logistic unit loads can be collected, according to an optimised route of packages. This depends in particular on the distance between the product picking space and the package picking space.

The invention also provides for a computer program comprising instructions which, when the program is executed by a computer, instruct the computer to implement the steps of the method described above.

The invention also provides for a computer-readable storage medium comprising instructions which, when they are executed by a computer, instruct the computer to implement the steps of the method described above.

The invention also provides for an installation for preparing a logistic unit load to be packed, comprising:
a product picking space, the space including product locations, each product location being associated with an identifier;
a package picking space, the space including package locations, each package location being associated with an identifier;
a product selection module, the selected products forming a logistic unit load to be packed;
a package selection module;
a module for obtaining a route for collecting the selected products and the selected package in the picking spaces, the route comprising the identifiers of the locations of the selected products and package;
means for collecting the selected products and package in the picking spaces according to the route and the selections;
a space for preparing a logistic unit load to be packed, adapted to arrange the selected products in the selected package, in order to form the packed logistic unit load.

This installation is therefore adapted to implement the method described above, generating all its technical effects.

Advantageously, the picking spaces consist of racks.

Preferably, the product and package picking spaces consist of a single picking space including both package locations and product locations.

Alternatively, the package picking space only includes packages corresponding to a single predetermined package type, a package type corresponding to the structure, the material and/or the robustness of the package, and this package picking space is integrated in the preparation space, so that any logistic unit load whose products are arranged in this preparation space is packed using a package corresponding to the predetermined package type.

Advantageously, the collection means are automated means adapted to automatically collect the selected products and package in the picking spaces and to take them automatically to the preparation space.

Generally, some of the steps, or all the steps, of the method described above, can be automated.

The invention also provides for a method for selecting packages that are optimised according to logistic unit loads, implemented by computer and comprising the following steps:
obtaining a list of packages;
for each of the packages on the list obtained, determining a prioritisation value for the package, the value depending at least on the volume of the package so that a package that is less voluminous than another one takes priority, all other things being equal, over this other package;
sorting the packages according to their respective prioritisation values in order to form a sorted list of the packages;
choosing one of the packages on the list according to the sorting;
obtaining a list of logistic unit loads, each logistic unit load on the list having dimensions that are smaller than those of the chosen package;
for each logistic unit load on the list, checking the adequacy between the chosen package and the logistic unit load, the check concerning at least the weight of the logistic unit load with respect to a maximum weight supported by the package;
if the number of logistic unit loads checked as being adequate for the chosen package is greater than or equal to a predetermined threshold, selecting the package and removing, from the list of logistic unit loads, the logistic unit loads checked as being adequate for this selected package.

Thus, although the instinctive approach would be to try to find, for each logistic unit load, the package that could be the most adequate for this logistic unit load, the method tries on the contrary to find, for each package, the number of logistic unit loads that could be packed inside it. This method can be used to test packages and only select among them those which, most often, could be adequate for the logistic unit loads selected. This avoids having numerous package references, it being possible to select only the packages that are most appropriate for the logistic unit loads, and therefore save package storage space in the warehouse.

In particular, by previously sorting the packages according to a prioritisation criterion taking into account at least the volume of each package, the checks carried out to ensure that each package is adequate for the logistic unit loads will start with the package that has the highest priority, at least in terms of volume, with respect to the other packages. However, if the package is selected, removing the logistic unit loads that have been checked as being adequate for this package from the list of logistic unit loads ensures that the next packages on the sorted list, therefore with lower priority in terms of volume, can only be compared with other logistic unit loads. Since only the packages adequate for a predetermined number of logistic unit loads are selected, the first packages on the sorted list, in other words the smallest, are therefore selected in priority. This ensures that the smallest possible packages as regards the logistic unit loads are selected, and therefore reduces as much as possible the void rates of the future logistic unit loads packed by these selected packages.

Note that the package list can be obtained using package references that have already been used by the logistician, in order to determine the package references to be kept in the future and those that the logistician can ignore since the packages are not used often enough or are too voluminous. However, the package list can also be obtained using packages other than those used in the past, for example using catalogues of package references belonging to package suppliers different from the usual supplier, or to suppliers acting as collection organisation and allowing the logistician to include packages from the circular economy, in order to determine whether, from these packages that have not yet been used, some could be adequate regarding the selected logistic unit loads. Lastly, the package list can be obtained using a mixture of packages that have already been used, and new packages to be tested, to compare them and only keep those most appropriate for the logistic unit loads selected.

Similarly, the list of logistic unit loads can be obtained using logistic unit loads shipped previously, but it can also be obtained using logistic unit loads that have not yet been shipped, that the logistician wants to test, in particular since the latter considers that they will have to be shipped in the future, such as for example a new item reference, to anticipate the packages that must be available when the time comes to pack these logistic unit loads.

In addition to “computer”, we will also speak of “computer means” and for convenience of “means”.

Other optional characteristics taken alone or in combination are described below.

Preferably, the list of logistic unit loads obtained includes logistic unlit loads that have been shipped previously.

Thus, the means identify the packages appropriate for the logistic unit loads shipped previously in the past by the logistician. However, a logistician often works on the same types of logistic unit load, so the logistician's packages are very likely to be appropriate for the future logistic unit loads to be packed. In other words, the method is therefore based on a history specific to a logistician, and allows the latter to select packages specific to their activity. For different histories, the method therefore provides different selections of packages.

Advantageously, the list of packages obtained includes:
packages from at least two different package suppliers; and/or
at least one package from a collection organisation; and/or
at least one made-to-measure package for a specific logistic unit load and/or
at least one reusable package.

Thus, the identification method concerns packages from all sources. It can therefore be used to identify adequate packages among the largest possible choice and it can also be used to take into consideration a large number of criteria.

Advantageously, the method comprises, for each package on the package list obtained, repeating the steps of choosing packages from the list according to the sorting, obtaining the list of logistic unit loads, checking the adequacy and removing the logistic unit loads from the list if the package is selected, to obtain a list of selected packages.

Thus, other, or even all the packages on the package list are tested, but since the logistic unit loads considered to be adequate for the packages tested previously are removed, the lower the priority of the packages, the less likely they are to be selected unless, despite their non-priority nature, they are adapted for a sufficient number of logistic unit loads that are not adequate with respect to the packages tested previously. The method therefore generates a good balance promoting the priority packages but allowing the selection of lower-priority packages if they are particularly adapted to the dimensions or types of logistic unit load often shipped.

Preferably, packages corresponding to the selected packages are then obtained, and logistic unit loads are packed in these packages.

Thus, real packages are obtained corresponding to the package references selected using the method.

Advantageously, the adequacy check further concerns a void rate of the chosen package in which the logistic unit load would be packed, with respect to a predetermined threshold.

Thus, a selected package is one that has been considered not only adequate for a sufficiently high number of logistic unit loads, but also on the basis of the void rate it generates with these logistic unit loads. This therefore ensures that only packages generating void rates below a predetermined threshold, possibly chosen by a user, are selected.

Preferably, the check further concerns at least the presence of a part of the logistic unit load classified as fragile with respect to the chosen package, and/or the arrangement of the contents, forming the logistic unit load, in the package, with respect to an arrangement to be respected as regards the fragility of the logistic unit load.

Advantageously, obtaining the list of logistic unit loads further concerns only logistic unit loads associated with the same package type as a chosen package type, the package types corresponding to a package material, structure and/or robustness.

Thus, the packages are tested by similar package types.

Preferably, the method further comprises, to select other packages, implementing the following steps:
from the list of logistic unit loads, identifying logistic unit loads for which no package has been considered to be adequate at the end of the checking step, to obtain a list of logistic unit loads identified as having no adequate package;
each logistic unit load on this list having, with a virtual shape of a rectangular cuboid, a first dimension, a second dimension orthogonal to the first dimension and a third dimension orthogonal to the first and second dimensions, distributing the values of the first dimensions, the values of the second dimensions and the values of the third dimensions of the logistic unit loads, into respective clusters of first dimensions, second dimensions and third dimensions;
identifying, for each cluster, a value of dimension specific to the cluster, in particular a maximum value of each cluster;
combining the identified values of the clusters of first dimensions with the identified values of the clusters of second dimensions and with the identified values of the clusters of third dimensions, in order to determine new packages having the combined dimensions.

Thus, the means execute a hierarchic clustering algorithm, in order to group the values of the first, second and third dimensions of the logistic unit loads around clusters specific to each of these three dimensions, according to predetermined numbers of clusters for each dimension. These means then assign values to each of these clusters, in particular the maximum values of each of these clusters, and combine these values in order to generate dimensions of fictitious packages. Since these dimensions result from values identified on the basis of the logistic unit loads obtained as input, they are appropriate for the largest number of these logistic unit loads.

Advantageously, the method comprises the following steps:
for each new package determined, checking the adequacy between the new package and at least some of the logistic unit loads previously identified as not having an adequate package, the check concerning at least the dimensions of these logistic unit loads with respect to the package dimensions;
if the number of these logistic unit loads checked as being adequate for this new package is greater than or equal to a predetermined threshold, selecting this new package.

Thus, for the “new” packages determined using the combinations of the values resulting from the clusters, a step of checking the adequacy between these fictitious packages and the logistic unit loads is performed, so that only the most appropriate are selected.

Preferably, the method comprises, beforehand, a step of determining the dimensions of each logistic unit load implemented as follows:
determining an arrangement plan for arranging products forming the logistic unit load;
determining the minimum dimensions of a container capable of containing the products arranged according to the arrangement plan determined;
assigning the minimum dimensions determined to the logistic unit load.

Thus, the means determine an arrangement of the products that is as compact as possible so that the logistic unit load is as small as possible.

Advantageously, the arrangement plan is determined as follows, the logistic unit load consisting of several contents to be arranged in a container, the contents and the container having respective virtual shapes of a rectangular cuboid, the method being implemented by computer and comprising the following steps:
among the contents to be arranged in the container, virtually arranging a first content at a predetermined position of the container;
in order to virtually arrange one of the remaining contents in the container:
   determining the dimensions and coordinates of several remaining empty spaces of the container, separate from each other and having respective shapes of a rectangular cuboid;
   determining possible positions of the remaining content in each empty space;
   determining respective distances between a predetermined top of the container and the respective tops of the remaining content in each possible position;
   depending on the distances determined, selecting one of the possible positions as virtual arrangement of the remaining content in the container;
repeating the previous arrangement steps for successively each of the other contents still to be virtually arranged in the container, in order to determine an arrangement plan for arranging all the contents in the container.

Thus, the container and the contents, as well as the empty spaces, are defined in the form of data structures processed by computer. Consequently, by arranging each content, in turn, in the position farthest away from a given point of the container, after identifying the empty spaces available, it appears that on average the position of these contents is significantly optimised so that the final arrangement of all these contents occupies the smallest possible volume. The minimum dimensions determined for the container are then as small as possible, and are assigned to the logistic unit load consisting of these contents. The packages then tested for this logistic unit load are therefore also as small as possible, since they are sorted at least by volume.

Preferably, the method comprises, beforehand, the following steps, to group contents in a logistic unit load:
scanning a list of shipments, each shipment having planned a delivery of one or more contents, and, for each shipment on the list, creating exclusive logistic unit loads for the shipment contents intended for exclusive packages, and creating at least one logistic unit load intended to group the other contents of the shipment not intended for exclusive packages, in order to form a list of logistic unit loads;
removing, from the list of logistic unit loads, at least one logistic unit load associated with a predefined package, if the package is on the list of packages obtained.

Thus, the means prepare logistic unit loads using orders provided as input, it being possible to organise these logistic unit loads differently from those which have been, amongst them, shipped in the past using these orders. In addition, the logistic unit loads associated with a predefined package and included in the package list are deleted since it is not relevant to test packages to be selected on logistic unit loads already dedicated to a specific package.

The invention also provides for a method for preparing a logistic unit load to be packed, comprising the steps of:
storing products in a product picking space, the space including product locations, each product location being associated with an identifier;
identifying packages according to the package selection method described above;
storing the identified packages in a package picking space, the space including package locations, each package location being associated with an identifier;
obtaining a selection of products, the selected products forming a logistic unit load to be packed;
obtaining a selection of a package from the stored packages;
obtaining a route for collecting the selected products and the selected package in the picking spaces, the route comprising the identifiers of the locations of the selected products and package to be collected;
collecting the selected products and the selected package in the picking spaces according to the route and the selections;
in a space for preparing a logistic unit load to be packed, arranging the selected products in the selected package, in order to form the packed logistic unit load.

The invention also provides for a computer program comprising instructions which, when the program is executed by a computer, instruct the computer to implement the steps of the method described above.

The invention also provides for a computer-readable storage medium comprising instructions which, when they are executed by a computer, instruct the computer to implement the steps of the method described above.

### BRIEF DESCRIPTION OF THE FIGURES

The invention will be better understood on reading the following description, given solely by way of example and with reference to the accompanying drawings in which:

FIG. 1 is a diagram of computer means used to implement the methods of the invention;

FIG. 2 is a flowchart showing a method for determining an arrangement plan according to a first embodiment;

FIG. 3 is a diagrammatic view of a plan for arranging contents according to this first embodiment;

FIG. 4 is a flowchart showing a method for determining an arrangement plan according to a second embodiment;

FIG. 5 is a diagram showing the embodiment of FIG. 4;

FIG. 6 is another diagram showing the embodiment of FIG. 4;

FIG. 7 is another diagram showing the embodiment of FIG. 4;

FIG. 8 is a diagrammatic view of a plan for arranging contents according to this second embodiment;

FIG. 9 is a flowchart showing a method for determining an arrangement plan according to a third embodiment;

FIG. 10 is a flowchart showing a method for determining an arrangement plan according to a fourth embodiment;

FIG. 11 is a flowchart showing a method for determining an arrangement plan according to a fifth embodiment;

FIG. 12 is a flowchart showing a method for grouping products in logistic unit loads, implemented in the package assignment method described;

FIG. 13 is a flowchart showing a method for assigning a package to a logistic unit load according to a first embodiment;

FIG. 14 is a flowchart showing a method for assigning a package to a logistic unit load according to a second embodiment;

FIG. 15 is a flowchart showing a method for selecting packages optimised according to logistics unit loads according to a first embodiment;

FIG. 16 is a flowchart showing a method for assigning packages optimised according to logistic unit loads according to a second embodiment;

FIG. 17 is a diagram of an installation for preparing a logistic unit load according to a first embodiment;

FIG. 18 is a drawing of a part of the installation of FIG. 17;

FIG. 19 is a drawing of another part of the installation of FIG. 17;

FIG. 20 is a flowchart showing a method for preparing a logistic unit load to be packed according to a first embodiment;

FIG. 21 is a diagram of an installation for preparing a logistic unit load according to a second embodiment;

FIG. 22 is a drawing of a part of the installation of FIG. 21;

FIG. 23 is a flowchart showing a method for preparing a logistic unit load to be packed according to a second embodiment; and

FIG. 24 is a flowchart showing a method for preparing a logistic unit load to be packed according to a third embodiment.

### DETAILED DESCRIPTION

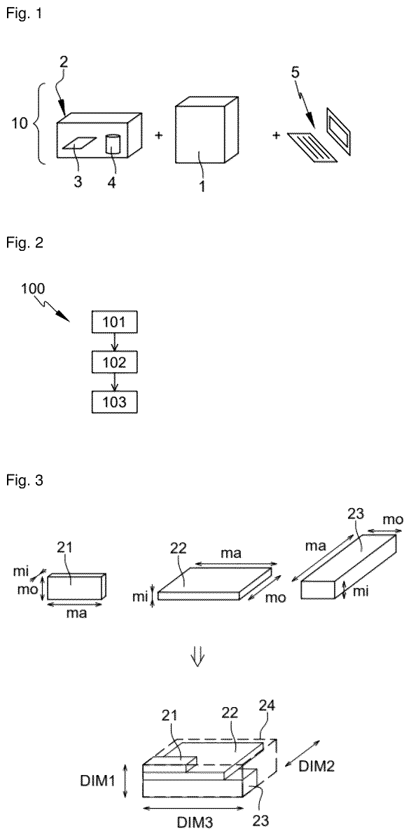

FIG. 1 shows computer means 10 for implementing the methods which will be described below. These computer means 10, conventional for those skilled in the art, include a processing unit 1 such as a processor, a memory 2, such as a data medium, including a computer program 3 and a database 4, as well as interaction means 5 for a possible user, such as a keyboard, a mouse. These means 10 form together a conventional computer, but they can also be distributed in any remote hardware. The program 3 comprises instructions which, when it is executed by the unit 1 or any computer, instruct them to implement the steps of the methods which will be described below. As a corollary, the medium 2 is any storage medium readable by the unit 1 or by any computer comprising instructions which, when they are executed by the unit or a computer, instruct them to implement the steps of the methods which will be described below. The interaction means 5 allow a user to configure the methods, in particular by assigning chosen values to certain thresholds, certain variables, or by selecting certain characteristics rather than others, according to the thresholds, characteristics and other configurable parameters that will be clearly apparent to those skilled in the art in the methods described below. Whether the steps are described generally, or whether computer means are explicitly mentioned, the steps of virtual arrangements, comparison, choice, arrangement and assignment and other calculation steps described, as well as generally all the steps that will be clearly apparent to those skilled in the art as being of computer nature, are entirely implemented by the means 10, unless human intervention, for example by a user of the methods, is explicitly mentioned.

We will first describe a method for determining a plan for arranging several contents in a container, according to four embodiments.

We will then describe a method for assigning a package to a logistic unit load according to two embodiments.

We will then describe a method for selecting packages optimised according to logistic unit loads.

Lastly, we will describe a method for preparing a logistic unit load to be packed.

In the remainder of the document, “content” will designate any virtual or real object intended to be integrated in a real or virtual “container”. Unless otherwise explicitly specified, these two types of object have the shape of a rectangular cuboid. It will be clearly apparent to those skilled in the art that they are processed virtually, in other words only using their data, by the means 10, as described below. Thus, they are represented electronically by their three dimensions, and if necessary by their coordinates, in particular those of the contents in a container, in the form of structured data in databases. The computer means 10 use these data to process these elements in the methods described below. Obviously, the “real” contents and containers correspond to these virtual elements and do not necessarily have the shape of a rectangular cuboid, even less that of a perfect cuboid, but their respective virtual counterparts are necessarily recorded numerically as having the shape of rectangular cuboids to be subject of the methods that will be described. The way in which a real content or container of any shape is given dimensions of virtual rectangular cuboids is not the subject of this application and will not be described.

“Logistic unit load” designates a set of contents, in particular one or more commercial products, intended to be grouped together to be arranged in a common container for a delivery. This expression is different from the term “parce” in that a parcel is often associated with a state or status of the logistic unit load. In particular, a parcel is generally considered to be a logistic unit load provided with a delivery label, in transit or having arrived at its destination. The “logistic unit load” is different from any status related to a delivery. As for the remaining objects described, it will be clearly apparent to those skilled in the art that the expression “logistic unit load” will consistently designate a logistic unit load processed electronically by the means 10.

In short, “content”, “container” and “logistic unit load” designate entities processed by the means 10, so they could just as well be designated respectively by the expressions “virtual content”, “virtual container” and “virtual logistic unit load”, except in the few cases where it will be clearly apparent that their real counterparts are designated.

“User” will designate any human person trying to obtain the results of the methods described below. This may be in particular players working in a delivery warehouse, such as an order preparer, a buyer or a logistician.

As already mentioned, the implementation of the following methods assumes the possession of virtual objects, in the form of data structures, some of which correspond to real objects. In particular, it will be assumed that for each real content to be integrated in a real container, for example for a product to be packed in a real package in a warehouse, the means 10 have the dimensions of these elements in order to process corresponding virtual contents and containers using these data. The way in which these dimensions are obtained and how these data are organised is not the subject of this application. Similarly, the means 10 have databases comprising a multitude of variables relating to specific characteristics of the packages or other objects, such as the weight, the “fragility” or not of a product, the package “type”, and all the parameters as they will appear clearly on reading the description. The way these data are obtained beforehand and how they are organised in databases will not be described here and is not the subject of the application.

### I. Method for Determining an Arrangement Plan

An “arrangement plan” means a data report comprising at least indications on the result of the arrangement of certain identified contents. The arrangement plan may therefore comprise the minimum volume occupied by the arranged contents, in other words, in particular, the minimum dimensions of a container for these contents. It may also comprise the coordinates of each of these contents thus arranged, possibly associated with the orientations of these contents. In more detail, it may include a guide, for example displayed on a screen, presenting a tutorial of the way in which the contents are to be arranged successively.

The input data of this method are three-dimensional contents all having the shape of oriented rectangular cuboids. They are represented electronically by any data enabling the dimensions of these contents to be determined, such as the three values of the respective dimensions of each content. The method is designed to arrange them in the most optimum way possible in an empty three-dimensional space, in particular by minimising the volume of empty space resulting from the arrangement obtained when considering these contents arranged in a rectangular cuboid with dimensions adapted to the contents thus arranged. The output data form a plan for arranging these contents in an empty space, plan whose content varies according to the embodiments and the options chosen by a user of the method. The output data include the minimum dimensions of a container adapted to the contents thus arranged.

This method is implemented automatically by the computer means 10 described above. The contents correspond to real products, belonging to a given logistic unit load, and that must therefore be arranged together in the most optimum way possible in a given package, a given pallet, a given container or a given lorry. They can also correspond to different pallets that must be arranged together in the most optimum way possible in a given container or in a given lorry, or even to different containers to be arranged in the most optimum way possible in a given lorry.

We will describe a first embodiment 100 of a method for determining arrangements of several contents in a container, referring to FIGS. 2 and 3.

FIG. 3 illustrates three contents to be arranged 21, 22 and 23, as well as the result of the arrangement plan. The following steps describe how this arrangement is obtained.

In step 101, the data corresponding to these contents 21, 22 and 23 are retrieved. In particular, they are the dimensions of the products to be arranged, these products having the shape of rectangular cuboids. Each content, like each container in fact, therefore has a first dimension, a second dimension orthogonal to the first, and a third dimension orthogonal to the first and second dimensions. Each content also has an orientation.

In a first variant of this step, the means 10 reorganise the dimensions of each of the contents, according to their values. Thus, the means 10 determine, for each one, which is their smallest dimension among their three dimensions, the smallest dimension that is assigned to the “first dimension” of the content in database. Their respective largest dimensions are also determined, that the means assign to the “third dimension” of the content. The remaining dimension is assigned to the “second dimension” of the content. FIG. 3 shows the dimensions mi, ma and mo, corresponding respectively to the “first dimension”, “second dimension” and “third dimension” of each content.

In a second variant not shown, at least for some of the products to be arranged, their respective smallest, largest and intermediate dimensions are not determined, and these dimensions are therefore not reorganised. Thus, for each of these products, the means 10 simply retrieve a first dimension, such as that provided first in a list of dimensions of the product, a second dimension and then a third dimension, and assign them respectively to the first dimension, the second dimension and the third dimension of each content. Thus, the first dimension of the content is not necessarily the smallest, the third dimension the largest, etc. This option is interesting for products for which a user wants to set the orientation, such as a bottle which should necessarily be oriented vertically. If, for example, the third dimension corresponds to a vertical z axis, the user can freeze the orientation of this product according to this orientation by indicating the height of the product as third dimension and by not allowing the means to reorganise the dimensions.

In step 102, an arrangement is determined as follows:
adding the values corresponding to their respective “first dimensions” mi, so as to obtain a first dimension of the space 24 containing them. On FIG. 3, it is the dimension “DIM1”;
identifying the largest value corresponding to the “second dimension” mo among the second dimensions of the contents, so as to obtain a second dimension of the space containing them. On FIG. 3, it is the dimension “mo” of the content 22, renamed “DIM2”;
identifying the largest value corresponding to the third dimension ma among the third dimensions of the contents, so as to obtain the third dimension of the space 24 containing them. On FIG. 3, it is the dimension ma of the content 23, renamed “DIM3”.

In step 103, a bounded space 24 is then obtained, having the shape of a rectangular cuboid and containing an arrangement of the three contents as shown on FIG. 3, in other words in particular with the three contents juxtaposed according to their respective first dimensions, oriented along the largest of their second dimensions and along the largest of their third dimensions so that the largest of the second and third dimensions border the group.

This space contains the contents arranged as described, which can be provided to a user via the interaction means, by displaying the arrangement on a screen, and/or by transmitting the coordinates of the arranged contents. The resulting dimensions of the space, which therefore correspond to the respective sums of the first dimensions, the largest of the second dimensions and the largest of the third dimensions of the contents, may also be provided to the user.

It also follows that if, according to the first variant, the first dimensions correspond to the minimum dimensions of each product, it is particularly advantageous for the contents to have been juxtaposed along these minimum dimensions.

As will be described below in the context of the method for assigning a package to a logistic unit load, a user can then choose a real container, such as a package, a pallet, a container or a lorry, corresponding as optimally as possible to these dimensions, in which the real contents can be arranged according to the plan determined. In particular, the means determine the “minimum dimensions” of the container containing these contents, these three “minimum dimensions” simply corresponding to the sum of the first dimensions of the contents, to the largest of the second dimensions of the contents and to the largest of the third dimensions of the content. The plan obtained provides the arrangement of the contents to be respected for the container.

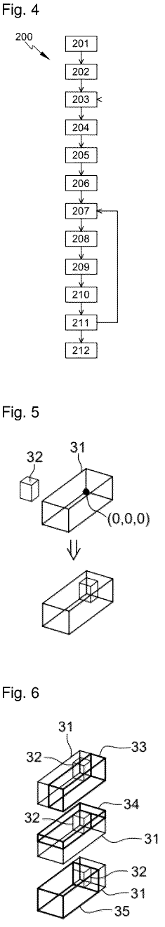

We will now describe referring to FIGS. 4 to 7 a second embodiment 200 of a plan for determining the arrangement of the contents in a container.

In step 201, the data of the contents to be arranged are retrieved, as in step 101. Step 202 corresponds to the formation of a first bounded space which will restrict the search for the optimum arrangement in the next steps. The dimensions of this bounded space are therefore the “maximum dimensions” of the container, which cannot be larger. To do this, the means 10 identify the most voluminous content among the contents to be arranged in the container. Then they determine a value, called “value to be added”, corresponding to the sum of the maximum dimensions of each content except the most voluminous content. In other words, they identify, for each of the contents except the most voluminous content, which dimension out of the three dimensions of the content is the highest, before adding these dimensions together. The means then assign to the first dimension of the bounded space, in other words to the “first maximum dimension of the container”, the sum of the first dimension of the most voluminous content and the “value to be added”. They assign to the “second maximum dimension of the container”, the sum of the second dimension of the most voluminous content and the “value to be added”. Similarly, they assign to the “third maximum dimension of the container”, the sum of the third dimension of the most voluminous content and the “value to be added”. In other words, this bounded space consists, in the three dimensions, of the largest possible juxtaposition of the three contents. It is therefore certain that the contents cannot be arranged in a larger space if they are juxtaposed to each other. Note that this bounded space, forming the maximum dimensions of the container, therefore depends on the dimensions of the contents to be arranged in the container.

We now consider that this first bounded space or first empty space forms the container in which the contents are to be arranged. It is the space 31 on FIG. 5.

In a variant of this step 202, this first bounded space or first empty space, which therefore corresponds to the maximum dimensions of the container, is determined differently according to the dimensions of the contents to be arranged in this container. In particular, as described later in the context of the method for assigning a package to a logistic unit load, the maximum dimensions of the container correspond to a package chosen beforehand so that it can integrate the contents to be arranged. Once again therefore, the maximum dimensions depend on the dimensions of the contents to be arranged.

This bounded space can be calculated in different ways.

Thus, in step 203, one of the first contents, in this case a content 32, is placed virtually in the empty space 31, at a predetermined position of this container 31. “Virtual” placement or arrangement means that it is the computer means 10 that consider the arrangement, to perform intermediate calculations, without this generating a real effect or a final result. A “virtual” placement or arrangement does not necessarily mean that the arrangement is displayed virtually on a screen. It is different from a real arrangement or real placement where an arrangement would really be made using real contents and containers.

This predetermined virtual placement position corresponds for convenience to the placement of a top of the content 32 at the coordinates (0, 0, 0) of the container 31, in other words in a corner of the container 31, juxtaposed to at least three of the four virtual “walls” of the container.

As a variant, the method can be configured beforehand so that the first content to be placed is that with the largest volume among the contents to be arranged.

In another variant, the volume is replaced by one or more other characteristics specific to the contents, or it is combined with this characteristic or these other characteristics. These additional characteristics correspond to the weight of the contents, its fragility, its perishability, its radioactivity level or another characteristic chosen by the user and available to the means 10, in other words recorded in database. For example, the heaviest or least fragile content is placed first, and so on. In the event of a combination, the means 10 determine a value combining these characteristics to perform the sorting. This variant can be chosen by a user wanting to take into account the characteristic(s) of their choice. They therefore configure the method accordingly.

In step 204, the resulting empty spaces in this container are determined according to the document “GONçALVES, José Fernando and RESENDE, Mauricio GC. A biased random-key genetic algorithm for 2D and 3D bin packing problems. International Journal of Production Economics, 2013, vol. 145, no. 2, p. 500-510”, referred to in the remainder of this document as “reference 1”, itself referring to the document “LAI, K. K. and CHAN, Jimmy WM. Developing a simulated annealing algorithm for the cutting stock problem. Computers & industrial engineering, 1997, vol. 32, no. 1, p. 115-127”, referred to in the remainder of this document as “reference 2”. Thus, the computer means 10 determine in the container the largest possible empty spaces having the shape of a rectangular cuboid, shown on FIG. 6 by the spaces 33, 34 and 35, taking into account the position of the first content 32 placed virtually in the container 31. The coordinates and/or dimensions of each of the empty spaces 33, 34 and 35 are thus known by the means 10.

In step 205, some of the empty spaces determined are excluded. In particular, these are the empty spaces whose dimensions are too small to include one of the contents still to be arranged, or spaces included in other larger empty spaces. This step does not exclude any space in FIG. 6.

In step 206, one of the contents still to be arranged is chosen. Optionally, the contents still to be arranged may have been sorted beforehand by decreasing volume, or according to one or more other characteristics, so that the choice of the content to be arranged is determined by this sorting. This sorting may have been configured in this way beforehand by a user.

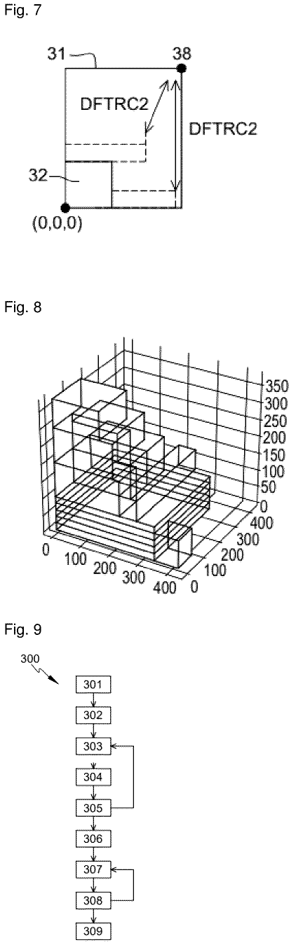

In step 207, the chosen content is placed according to the heuristic principle called DFTRC2 of “reference 1”, as shown on FIG. 7. This figure shows, in two dimensions, two possible positions of a content still to be arranged in the container 31, either above or beside the content 32. The distances between these possible positions and the corner 38 of the container are calculated and compared, before choosing the position corresponding to the longest distance. Obviously, FIG. 7 shows this principle in two dimensions for simplicity purposes, but the means 10 consider all the objects and therefore distances in three dimensions. In other words, the means 10 virtually place the chosen content in each of the empty spaces selected in step 205, with a top of the content as close as possible to the origin (0, 0, 0) of the container, and they calculate, in each of these positions, the distance between another predetermined point of the container and the top of the content closest to this point. As already mentioned, by “place”, it is understood that the computer means 10 “consider” a position, without it being constructed virtually, but only for calculation purposes. The predetermined point 38 of the container used to calculate these distances corresponds to the coordinates farthest away from the origin (0, 0, 0), it is therefore the top of the container opposite this origin in three dimensions. The position chosen, among the positions tested, is that corresponding to the greatest distance calculated.

Note that “reference 1” refers to a Euclidean distance of type

$${Dist}^{2} = {( D - x - dBO )}^{2} + {( W - y - wBO )}^{2} + {( H - z - hBO )}^{2} \qquad Formula 1$$

Where D, W and H are the dimensions of the container 31, x, y and z are the coordinates of the maximum empty space considered, and dBO, wBO and hBO are the dimensions of the content 32 in a given BO (Box Orientation).

In the context of the invention, it is preferred to use the following distance:

$$DDist = \sqrt{\vert D - x - dBO \vert} + \sqrt{\vert W - y - wBO \vert} + \sqrt{\vert H - z - hBO \vert} \qquad Formula 2$$

In fact, this distance turns out to give arrangement results that are more optimised on average.

In step 208, the step of determining the resulting empty spaces of step 204 is repeated, this time with the container including the first and second contents arranged.

In step 209, the step 205 of excluding certain resulting empty spaces is repeated.

In step 210, one of the other contents still to be arranged is selected.

This content is chosen according to a sorting of the contents carried out beforehand, in particular if, as mentioned in step 206, the contents have been sorted by decreasing volume or according to one or more other characteristics. However, it can also be chosen according to an order predetermined by a user, or randomly. It is this latter case that is applied in particular with reference to the embodiment 300 described below.

In step 211, step 207 is repeated with this content.

These steps are repeated until all the contents to be arranged are virtually arranged by the means 10 in the container determined in step 202.

In step 212, a minimum space is then determined, having the shape of a rectangular cuboid, containing the contents thus virtually arranged. The means thus determine firstly its dimensions and its volume, and secondly form the arrangement plan to be provided to the user, who can then apply it to their real contents. An example of a virtual arrangement with multiple contents, obtained by this method 200, is shown on FIG. 8.

In numerous cases, due to the steps of virtual placement according to the maximum empty spaces determined, this minimum space will be less voluminous than the bounded space 31 determined in step 202 and less voluminous than the space determined by the method 100.

Once again, as at the end of the method 100, it is then possible to provide to a user the way in which the contents have been arranged virtually, by means of a screen and coordinates, and the arrangement plan can also contain, in addition to these elements, the minimum dimensions determined in order to choose an optimised package, pallet, container or lorry.

In optional steps not shown, the possible orientations of the content are part of the possible positions of each content, of the first as well as of the contents still to be arranged. Thus, during step 207, not only the different possible locations of a content oriented in the same way are tested, but also the various possible orientations of the content for each possible location. The various possible “BOs” (Box Orientations) in the equation described above are therefore tested.

Similarly, when placing the first content in step 203, the distances of step 207 can be compared for each possible orientation of this content in the predetermined location, at position (0, 0, 0), in order to choose the orientation for which the distance is greatest.

The number of orientations tested for each content, or even the choice of orientations tested, can be configured beforehand by a user of this method 200. This configuration can be applied to all the contents indifferently, but it can also be specific to each content. Thus, certain orientations can be authorised for one content but not for another.

We will now describe, referring to FIG. 9, a third embodiment 300 for determining an arrangement plan, implementing a biased random-key genetic algorithm, part of which is described in “reference 1”.

In step 301, as in steps 101 and 201, the data corresponding to the contents to be arranged are retrieved.

In step 302, the contents are sorted by decreasing volume.

In step 303, the computer means 10 determine a sequence of random numbers between 0 and 1, these being the random keys, or digital scores.

In step 304, and in a manner not described in reference 1, the means 10 reorder the contents according to this sequence and their initial position in the list sorted by decreasing volume. For example, for a list of three contents, if the random sequence consists, in this order, of scores 0.3, 0.7 and 0.4, the means reorder the contents by placing the least voluminous of these contents in first position since 0.3 is the smallest score, the largest of the contents in second position since 0.7 is the largest score and the content with the intermediate volume last, since 0.4 is the intermediate score. Thus, the random sequence defines an order, or a sequence, of the contents to be arranged according to a first arrangement plan. This principle will be reused below.

In step 305, the means 10 determine this first arrangement plan according to the method 200 described above, in other words by looking for the maximum spaces available. The order of the contents to be arranged is defined by the sorting of step 304. Note that while “reference 1” suggests allocating numerical scores also to the various orientations of the contents, which are therefore processed like contents, the invention also provides as an alternative carrying out the method 200 by testing all or some of the possible orientations taking into account the configuration constraints or the characteristics of each of the contents to be arranged, when choosing the positions of the contents in the empty spaces, it being possible to configure the number of orientations tested. Thus, the orientations are chosen in the method 200.

Then, steps 303 to 305 are repeated, therefore with new numerical scores generated, for the same contents, in order to obtain several arrangement plans for several different arrangement orders for the same contents, until all the contents to be arranged have been chosen first. As a variant, a limited number of repetitions can be set, configured beforehand. All the arrangements determined form an initial population, or initial generation, of arrangement plans.

In step 306, the means 10 determine the void rate of each minimum container determined in the arrangement plans of this initial population. To calculate the void rate, the means divide the volume of a container having the minimum dimensions, determined by the arrangement determination method 200, by the sum of the volumes of the contents. The means 10 then store the results of the methods 200 implemented in step 305 and therefore the various arrangement plans, associated with their void rates.

In the next steps, the means then create a next generation of arrangement plans of the same contents.

Thus, in step 307, the means 10 implement a step, according to the genetic algorithm, of selecting some of the plans of the initial population. This selection is carried out on the basis of the calculated void rate. Thus, the means classify the plans by void rate, and only select a predetermined number of these arrangement plans, for example the plans corresponding to 20% of the plans with the lowest void rate.

In step 308, the plans selected, forming “the elites”, are crossed over with each other and/or with the other remaining plans of the initial population, according to the genetic algorithm. Thus, to perform this crossover, it must be noted that each of these plans remains associated with a series, or sequence, of scores between 0 and 1, and a void rate of this sequence. In this context, the means 10 randomly determine the position of the score from which the means 10 switch, two by two, the scores of these two selected sequences, called “parents”, in order to generate “child” sequences comprising first scores identical to those of one of the parent sequences and next scores identical to those of the other parent sequence. By reproducing these crossovers on several parent sequences resulting from the “elites”, the means produce several child sequences. Each of these “child” sequences therefore consists of a sequence of scores between 0 and 1, each forming a new order of the contents to be arranged.

Thus, in step 308, the plans resulting from the crossover, which form the generation which followed the initial population, undergo the steps of the method 200 for each of the “child” sequences, by determining their arrangement plan. Then, their respective void rates are determined in turn.

Once again, the selection 307 and crossover 308 steps are performed according to these void rates, to form next generations of arrangement sequences. The population which followed the initial population therefore replaces the latter to repeat the selection and crossover steps, to form a new generation, which in turn undergoes the selection and crossover steps, and so on.

During these steps, each arrangement plan determined on the basis of these arrangement sequences, and each void rate of these plans, are saved by the means 10.

Steps 307 and 308 are no longer repeated when a predetermined number of iterations, in particular configured by a user, is reached, or when the means determine that the void rates of the successive plans no longer decrease sufficiently, or even increase, after the crossover steps 307 and 308 of the last child generation.

As a variant, the stop condition could be that a given plan has reached a predetermined void rate.

In step 309, the means 10 choose the arrangement plan having, among all the arrangement plans determined in all the steps, in other words of all the populations, the lowest void rate. Thus, it is this arrangement plan which is the result of this method 300.

In a variant, among all the arrangement plans determined in all the steps, in other words of all the populations, the means 10 identify the arrangement plans which respect to one or more criteria selected beforehand by the user. These criteria concern the weight, fragility, radioactivity level, or perishability of the contents arranged. For example, if the user configured the means 10 to require an arrangement organised according to the weight of the contents, then the means 10 only identify the arrangement plans in which the heaviest contents are located under the lightest contents. If the criterion only refers to a radioactivity level, the means identify the plans in which a highly radioactive content is surrounded by contents limiting the emissions of radioactive substances outside the container, for example. Then, among all the plans identified as corresponding to one criterion or a set of selected criteria, the means 10 determine the arrangement plan having the lowest void rate, this plan then forming the result of this method 300.

Optionally, in addition to the crossover step, the means 10 also perform a step of mutation between two successive generations. Thus, they randomly modify one or more of the numerical scores of one or more parent or child sequences. This mutation step increases the level of chance in the order of the contents to be arranged in order to explore arrangements that would not have been explored otherwise through the parent filiation.

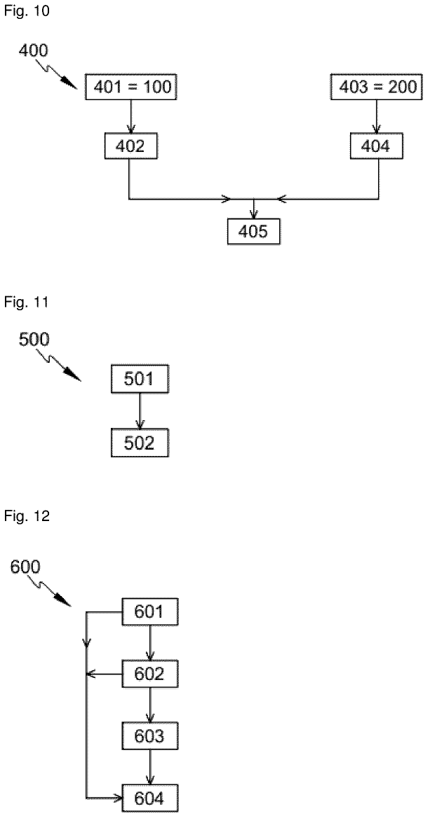

This embodiment 300 is more optimised than the method 200 since it compares the results of several methods 200 based on different content arrangement sequences, in other words content arrangement orders. In particular, for a large number of contents to be explored, this method 300 can generally be used, on average, to optimise the void rate compared with a method 200 which would be based on an arrangement with a random or arbitrarily fixed order, for example with the contents arranged in a given order by their volume, in descending order. In addition, the method 300 avoids having to exhaustively scan the arrangement possibilities compared with a traditional algorithmic approach where all the possibilities would be explored. It can therefore be used to find an exact solution or one close to an exact solution more rapidly. We will now describe, referring to FIG. 10, a fourth embodiment 400 for determining an arrangement plan. It consists in implementing at least two of the three embodiments 100, 200 and 300 described previously, comparing the arrangement plans determined by each one of them, and selecting the most appropriate one.

Thus, in step 401, the means 10 implement the method 100 for determining a first plan for arranging the contents in a container.

In step 402, these means determine the volume of the container resulting from this arrangement plan, in other words resulting from the determined arrangement of the contents 5 in the container corresponding to the minimum dimensions determined in step 103.

In step 403, the means implement the steps of the method 200 to determine a second plan for arranging the contents in a container.

In step 404, these means 10 determine the volume of the container resulting from this second arrangement plan, in other words resulting from the determined arrangement of the contents in the container corresponding to the minimum dimensions determined in step 212.

In step 405, the means select, among the two plans, the one whose resulting container has the smallest volume.

Alternatively, rather than comparing the volumes, the means compare the void rates generated by the containers determined for these contents.

Alternatively, in step 403, it is not the steps of the method 200 that are implemented but the steps of the method 300. In this case, obviously, the means determine in step 404 the volume of the container resulting from the plan determined by the method 300, and it is this volume that is compared in step 405. The choice between the method 200 and the method 300 can depend on a service level chosen by a user. Thus, if the service level requested is simple, the arrangement plan of the method 100 is compared with that of the method 200. If the service level requested is more complex, the arrangement plan of the method 100 is compared with that of the method 300.

Obviously, in this embodiment 400, the steps of the methods 100 and 200 or 100 and 300 can be executed in a different order or in parallel.

This embodiment 400, based on two approaches and the comparison of their results, can be used to optimise the arrangement plan for each set of contents to be arranged. In fact, if, on average, the method 200, and even more so the method 300, provide more optimised arrangements than those of the method 100, in other words with smaller dimensions of final containers and therefore lower void rates, in some cases the volume of the container determined by the method 100 may be smaller than that resulting from the other embodiments, for the same contents to be arranged. By comparing the results of the methods 200 or 300 with that of the method 100, the most optimum arrangement is always chosen. In addition, the computational effort due to the method 100 is relatively low compared with those due to the method 200, and especially to the method 300, so the additional time allocated to this method 100 and to the comparison of volumes or void rates is negligible.

As a variant, the results of the methods 200 and 300 could obviously be compared. The three methods 100, 200 and 300 could also be implemented and their results compared.

We will now describe, referring to FIG. 11, a fifth embodiment 500 for determining an arrangement plan.

In step 501, the means 10 retrieve the data corresponding to the contents to be arranged, but also, and this is the difference compared with the previous embodiment, those corresponding to a container. This container can be obtained by these means 10 from a list of containers, possibly sorted. The container can for example correspond to a package in which the arrangement of the contents is to be tested virtually. Thus, in the context of this embodiment, step 202 of the embodiments 200 to 400 described previously for generating a first empty bounded space is not performed, since this first empty bounded space in which the contents are to be arranged is, in this embodiment 500, that of the chosen container.

In step 502, all the steps of the method 300 for these contents and this container are performed, the only difference being the absence of step 202, as explained above, replaced by the step of providing the dimensions of the container. The random-key genetic algorithm is therefore used to determine a plan for arranging the contents in the chosen container.

In other words, this fifth embodiment 500 is the application of the genetic algorithm of the method 300 described above to contents for a container defined beforehand. The objective is therefore no longer to determine the minimum dimensions of a container containing the contents, but only the arrangement of these contents in this container provided beforehand.

In a variant of step 502, all the steps of the method 200 are performed, but not the other steps of the method 300. Thus, only one virtual arrangement plan is determined using the steps of the method 200, for these contents and this container. In this variant, the step 202 of determining the maximum dimensions of the container corresponds to providing the dimensions of a package chosen beforehand so that it can integrate the contents.

This embodiment 500 is particularly useful to test several containers corresponding to real containers, for example packages available in a warehouse, in order to choose the one in which the arrangement of the contents is the most appropriate. This embodiment will thus be mentioned below in the context of an embodiment 800 of a method for assigning a package to a logistic unit load.

We have thus described five embodiments of a method for determining a plan for arranging several contents in a container. They are all implemented automatically by the computer means 10, such as a computer, using the data corresponding to contents, and possibly, for the fifth embodiment 500, the data corresponding to a container.

The user implementing this method using a method 10 can therefore obtain one or more plans for arranging contents in a container. This is particularly useful in the case of a warehouse of logistic unit loads to be shipped. Thus, the order preparer no longer chooses the package visually, but chooses the package according to the dimensions of the virtual container resulting from the arrangement method. In addition, these means also provide the order preparer with the positions of the contents, in other words of the products, to be arranged in the way determined by the method, in the container. Thus, the order preparer does not have to worry about optimising the arrangement and simply follows the instructions provided by the means 10 using the arrangement plan determined. These instructions can, for example, be provided to the order preparer on a screen, showing the positions and orientations of the various contents corresponding to the logistic unit load that the order preparer must prepare.

Alternatively, these positions can be provided to other automated means, which then automatically arrange the products in the package themselves, according to the plan determined by the means 10.

By optimising the arrangement of contents in a container, and in particular by optimising the arrangement of the products of a logistic unit load in its package, this method can be used to choose packages that are more adapted, in particular having dimensions as close as possible to the optimised arrangements, and therefore to reduce the void rate of the packages. By automatically providing the arrangement and the adequate container, it provides and therefore allows the operational use of a larger variety of package types in a warehouse. It can be used to choose the optimum package and make an optimised arrangement without wasting time preparing the shipment of the packed logistic unit load.

As well as allowing products to be arranged in a package, this method can also be used to arrange several logistic unit loads, in particular packed, which form contents, in a pallet, a container or a lorry, which form a container. It can also be used to arrange several pallets, or several containers, which form contents, in a lorry, which form a container.

### II. Method for Assigning a Package to a Logistic Unit Load

The inputs of this method, implemented by the computer means 10, are data structures corresponding to products intended to be grouped together to form a logistic unit load to be packed. The output of this method is the choice of a package, among several possible packages, to pack each logistic unit load, before shipment. The order preparer can then choose the package indicated for the corresponding logistic unit load. Alternatively, the output of the method consists of ideal package dimensions to pack the logistic unit load, the package then requiring made-to-measure manufacture, manually or using a robot.

Managing Packages with Variable Dimensions

The precise dimensions of the packages are necessary in the methods described in this application. Consequently, in steps not shown, performed before or during the methods described throughout this application, the means 10 identify, among the packages used in the methods, the packages with “variable dimensions”. The usual dimensions of these packages may vary depending on how the user uses them. This is the case for plastic bags, but also for “bellows” type packages, or cardboard boxes with “variable dimensions”. The means 10 then implement computation methods known to those skilled in the art and specific to each type of package with variable dimensions, to determine their dimensions. This may involve in particular taking into account the dimensions of the package in its most extended configuration. Once these dimensions are known, they will be recorded for the respective packages and taken into account in the methods described in this application.

Grouping Products into Logistic Unit Loads

Referring to FIG. 12, we will describe a method 600 for grouping products into a logistic unit load, carried out before the method for assigning the package to a logistic unit load described below. It is implemented automatically by the computer means 10. These receive a list of shipments, each shipment consisting of products to be shipped to the same location, and therefore potentially grouped together.

In step 601, the means consider one of the shipping lists and determine whether it contains a single product. If this is the case, they create a logistic unit load, in other words a data structure associated with this logistic unit load, and include only the product therein. The logistic unit load moves to step 604. If this is not the case, and therefore if the shipment contains several products, it moves to step 602.

In step 602, the means check whether, in the shipment, some products are associated with an exclusive package requirement. For each of these products, the means create specific logistic unit loads, which are therefore only intended to contain this product, and the logistic unit loads move to step 604. For the other products in the shipment, the means create a single logistic unit load which will group these other products not requiring an exclusive package, and the means move to step 603 for this logistic unit load.

In step 603, the means 10 determine, among the products forming the logistic unit load, whether some of them are associated with specific characteristics involving special package requirements, in other words package “types”. “Package type” designates, throughout the application, a package associated with a specific kind of package, the packages of this kind, or type, having a similar structure or material. For example, a “double-corrugated package” corresponds to a particular package type, different from “single-corrugated” package types. A “cardboard” package is a type different from a “plastic” package or a “paper” package, or from a “composite material” package. As an alternative or in addition, the packages can be classified by “robustness” type, for example by a score, since generally one package type is more or less “robust” than another package type. The various package types are known to those skilled in the art and will not be listed exhaustively. This data type is recorded beforehand in a manner not described. In this case, in step 603, the means then associate with the logistic unit load the most robust package among the packages required by the products, if some of these products require a package with a particular robustness.

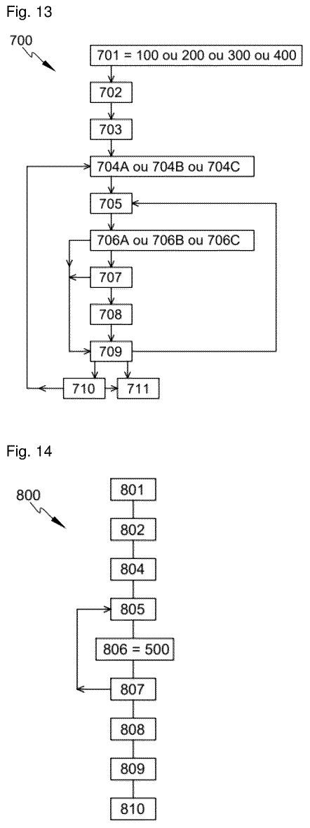

The logistic unit load is ready to move to the method for assigning a package, which will be described below according to two main embodiments 700 and 800 shown on FIGS. 13 and 14. If a package type has been selected in step 603 for this logistic unit load, the method for assigning a package will only be implemented for a list of available packages corresponding to the selected type.

Step 604 is only implemented for the logistic unit loads including only one product. The means 10 check whether this product is associated with an imposed package or with a precalculated package, in which case, if the user, in particular the order preparer, has a real package available, the method for assigning a package of the embodiments 700 and 800 does not need to be implemented. Otherwise, this logistic unit load, which includes a single product, is subjected like the others to the following method. “Precalculated” or “imposed” designates specific packages which have first been directly associated with the logistic unit loads, via corresponding indications in database, so that the method described below, used to choose a package among the available packages, is not required for these logistic unit loads. In particular, an “imposed” package is generally imposed on the product by the logistician. A “precalculated” package is determined by the means 10, in a manner not described, based on the logistician's order history.

Lastly, note that, for some logistic unit loads, including only one product, the product is “pre-packed”, in other words it already consists of a package. These products, and therefore the corresponding single-product logistic unit loads, are obviously excluded by the means 10 of this grouping method and are not subject to the following method for assigning a package, since by definition these logistic unit loads already consist of a package.

### Assigning a Package

Referring to FIG. 13, we will first describe a first embodiment 700 of a method for assigning a package to a logistic unit load. Like all the methods described, they are implemented by the computer means 10.

The means scan the list of logistic unit loads and consider them one after the other. The following thus concerns only one of these logistic unit loads to be packed, the same method being reproduced on the others.

If the logistic unit load comprises a single product, it moves directly to step 702, and it is assigned the dimensions of its product.

In step 701, the logistic unit loads comprising several products are subject to the method for determining an arrangement described above, according to the embodiment 100, 200, 300 or 400. In other words, the means 10, which store the data, in other words dimensions and other coordinates, of the contents having the shape of a rectangular cuboid corresponding to real products, determine the plan for arranging these contents, as well as the minimum dimensions of the container intended to contain these contents. The choice between the embodiments 100, 200, 300 or 400 of the method for determining an arrangement depends on a service level requested by a user, using a predetermined parameter. The choice can also be made occasionally by the user of the method for a logistic unit load or a group of particular logistic unit loads. At the end of this step, the minimum dimensions determined by the arrangement method, regardless of its embodiment, are assigned to this logistic unit load.

As a variant, the arrangement of the products in the container, and therefore the minimum container dimensions, could be determined separately, without affecting the steps performed before or afterwards in this method for assigning a package to a logistic unit load. In fact, all the steps of the method for assigning the package are independent of the steps of the method for determining the arrangement plan. However, it is advantageous, in order to reduce the void rate of the logistic unit loads, to carry out the method for determining an arrangement as described above according to its various embodiments.

In step 702, the means 10 obtain the list of packages available for this logistic unit load. These are the references of the packages available in the warehouse. As a variant, only the packages corresponding to a package type identified in step 603 are placed in the list of packages available for this logistic unit load.

In step 703, among the list of packages, the means 10 only select those that are physically capable of containing the logistic unit load, in other words whose first dimension is greater than the first dimension of the logistic unit load, whose second dimension is greater than the second dimension of the logistic unit load and whose third dimension is greater than the third dimension of the logistic unit load. As a variant, the invention provides more reliably for the selection of packages whose smallest package dimension is greater than the smallest dimension of the logistic unit load, whose intermediate dimension is greater than the intermediate dimension of the logistic unit load, and whose largest dimension is greater than the largest dimension of the logistic unit load. This therefore ensures that the selected packages are spatially capable of containing the logistic unit load. In another variant, this check/selection can be carried out subsequently, during step 707 described below.

In step 704, the means perform a step of prioritising according to criteria configured beforehand by the user, and of sorting according to this prioritisation, on the packages selected in step 703. According to a first option 704-A, this prioritisation is only performed according to the volume of the packages. Thus, the packages are sorted by increasing volume. In the following, we will speak indifferently of “criterion” or “characteristic”. It is a variable specific to an entity and known as such by the means 10.

As a variant, according to an option 704-B, a package durability criterion, or characteristic, is added to the volume of the packages. Thus, the packages are associated beforehand with a durability score according to their type, in particular a number between 1 and 2, but which could obviously lie within a different range. A reusable package is in particular associated with a lower durability score than a new package. A package that has been used a large number of times has an even lower score. The materials forming the package also play a role in the score assigned to the packages. These scores are defined beforehand, by a logistician or another user. To take them into account in addition to the volume in the context of this step 704-B, the means 10 multiply the real volume of the package by the associated durability coefficient. The resulting data can be called “fictitious volume”, since it associates the real volume of the package with a coefficient. The packages are thus sorted by increasing fictitious volume. Thus, for an equal real volume, a package recorded as being more durable than another will have a smaller fictitious volume, its durability score being smaller, and will therefore take priority.

As a variant, according to an option 704-C, at least one other characteristic can be taken into account, in addition to the real volume or the fictitious volume, to perform this step of sorting the packages. In particular, this could be the package price. To associate it with the real or fictitious volume of the package, the means 10 in this case normalise all the variables to be taken into account. Thus, they take into account all the criteria of all the packages to be sorted and normalise them according to the following formula:

$${x}_{normalis {e}^{′}} = ( max ( x ) - {x}_{i} ) / ( max ( x ) - min ( x ) ) , \qquad Formula 3$$

where x is the type of variable to be normalised among the real or fictitious volume, or the price, max (x) and min (x) are the maximum variables and respectively of the same type among all the packages, xi is the value of the variable to be normalised before normalisation. x_{normalised} is necessarily a value between 0 and 1.

After normalising the variables of the packages to be sorted, the means 10 add, for each package, these variables, according to the predetermined weighting factors. For example, it can be predetermined that the fictitious volume has twice as much priority as the price, so that the factor associated with the fictitious volume is 1 compared with 2 for the price, so that a high price generates a high sum. Then, the packages to be compared are sorted according to the result of their respective associated sums, in ascending order. As a variant, the factors can be assigned differently, by switching in the example the 1 and the 2, and sorting the sums in descending order.

According to a variant 704-C, other criteria, or characteristics, can be taken into account, such as the greenhouse gas emission rate associated with the package. The means normalise the variables as indicated above to obtain, in the same way, comparable data and sums forming a prioritisation value, so that the packages can be sorted.

At the end of step 704, and regardless of the variant implemented, the packages are now sorted, at least according to the real volume, or even by associating other criteria thereto. The result is that they are sorted, in such a way that, all other things being equal, a package with a smaller volume takes priority over a package with a larger volume. “All other things being equal” means that all the other variables are identical.

In step 705, the means 10 consider the first package on the list to be sorted, so that it undergoes the next steps. Since this package takes priority over the others, this is in fact the one that would be most appropriate for the logistic unit load if its assignment is confirmed. The means 10 determine whether margins are associated electronically with products forming the logistic unit load, and where applicable, assign the highest margin to the dimensions of the package ready for the next steps. Otherwise, the package itself may have been associated beforehand with a margin to be respected, therefore selected by the means 10 in the same way. Lastly, as a last resort, a global margin may have been configured beforehand by a user, which is then selected by the means 10 in this step. The result is that the “referenced dimensions” of the package chosen at the start of the step can be, at the end of this step 705, slightly modified by the means 10 to respect a margin, resulting in the “useful dimensions” of the package. “Useful dimensions” designates the dimensions used in the remainder of the method, except when calculating a void rate, as well as the package dimensions that can actually be used. In particular, without a margin, it may be difficult to arrange the planned products in the package. Thus, in the following, when the package dimensions are used, unless otherwise specified for the void rate calculations, reference will be made to the useful dimensions calculated in this step 705, and by default to the dimensions as they are referenced and known by the means 10. For the void rate calculations, however, reference will be made to the “real dimensions”, as explained below.

In step 706, the means 10 perform a step of checking the adequacy between the useful dimensions of the chosen package and the logistic unit load. In a variant 706-A, the means 10 only check whether the weight of the logistic unit load is really less than or equal to the maximum weight theoretically supported by the package. The weight of the logistic unit load is determined on this occasion by adding the weights of the products, known by the means 10 beforehand. Where applicable, the adequacy is confirmed, and the chosen package is assigned by the means 10 to the logistic unit load. Otherwise, the adequacy is invalidated.

In a variant 706-B, after confirming the weight, the means check a void rate generated by this package for this logistic unit load. This consists in calculating the volume of the package and dividing it by the cumulated volumes of the products of the logistic unit load. To this end, the means 10 use the “real” dimensions and not the “useful dimensions” of the package. In fact, if there is a margin, it increases the void and must therefore be counted as such. If the void rate is below a predetermined threshold, called the “individual void threshold”, for example 60%, the adequacy is confirmed, otherwise it is not. This threshold can be predefined by a user, for example a logistician, or chosen by a customer, for example a recipient or a shipper of the logistic unit load.

In a variant not shown of this step 706-B, void rates are compared not on a single logistic unit load but for a plurality of logistic unit loads. Thus, if the user has configured the method beforehand accordingly, in order to confirm or not that a logistic unit load is adequate for an assigned package, the means 10 calculate the average void rate of the logistic unit loads whose adequacy has previously been confirmed, for a given predetermined period (a given day, a given week, a given month) preceding the processing of this logistic unit load. If this average void rate is below a void threshold called “global void threshold” defined by the logistician, then the logistic unit load is confirmed as being adequate for the assigned package. Thus, even if this logistic unit load has an individual void rate associated with its package that is greater than the planned individual threshold, it is nevertheless confirmed as being adequate since it follows a series of logistic unit loads associated with packages resulting in a sufficiently low average void rate. This reduces the average void rate of the logistic unit loads shipped, by tolerating that some of them retain void rates that are above a set individual threshold. In addition, according to this variant, it could be provided that, if the average void rate is greater than the global void threshold, rather than invalidating the adequacy of the current logistic unit load, the variant of this step 706-B as described above is implemented, in other words its individual void rate is compared with the planned individual void threshold.

It could be provided, by configuration, that some of the characteristics of the logistic unit loads as they are known by the means 10 do not require the void rate calculation and therefore this step 706-B and its variants.

In a variant 706-C, the means check, as well as or as an alternative to the void rate, whether the price of the chosen package is above a predetermined threshold, which may once again have been chosen beforehand by a user. This threshold is generally specific to each product. Thus, if the chosen package corresponds to a logistic unit load including several products, the means calculate the sum of the thresholds associated with each product to identify the maximum desired cost of the package.

If the package assigned to the logistic unit load has passed this step 706 according to at least one of its variants, in step 707 the means check several other adequacy criteria. Thus, the means identify in their databases whether among the products forming the logistic unit load there are one or more products considered to be “fragile”. Where applicable, the means 10 check that the package is itself recorded as being “capable” of containing a fragile product, or even of containing a product having the fragility type considered. Lastly, where applicable, the means 10 check whether the arrangement, determined by the arrangement method of step 701, respects the fragility of one or more of these products. In particular, it may be recorded that a product has specific characteristics involving package or placement requirements. For example, a fragile product must not be located under another product, or under another product having a weight greater than a predetermined value. The means 10 therefore check in this step whether these possible constraints, known as characteristics prerecorded in the databases, are respected by the arrangement plan. Where applicable, the allocation is confirmed, otherwise it is invalidated.

As a variant, the adequacy check may further concern the package dimensions, the means checking that each of the package dimensions is greater than or equal to each of the dimensions of the logistic unit load. This step is not necessary if the selection of packages in step 703 has already been checked.

In step 708, if the package is confirmed, it is assigned to the logistic unit load. The method for assigning a package to the logistic unit load then ends successfully.

In step 709, if the adequacy check has been invalidated in one of the previous steps and variants, the means select the next package in the sorted list resulting from step 704, and repeat steps 705 to 707, until a package is considered to be adequate, or until the end of the list of sorted packages has been reached. As a variant, the step may not be repeated when a predetermined number of packages having undergone steps 705 to 707 has been reached.

In step 710, if no package on the list has been considered to be adequate in steps 706 and 707, the means 10 can identify that packages not selected in step 702 are available in the warehouse, via their database. This concerns in particular the variant where only the packages having a certain type of robustness have been selected in step 702. Thus, in step 710, the packages of another type can be selected. This is in particular the case if the package type criterion selected is robustness, and there are packages of a more robust type in database. Consequently, steps 704 and after are repeated for the packages of this type. This step 710 may only be performed if the user has authorised it beforehand.

Step 711 is performed if no package on the list, or on the lists if step 710 has been implemented, has been considered to be adequate in steps 706 and 707 of checking the adequacy between the package and the logistic unit load. The means 10 then propose to the user, the logistician or the order preparer for example, the creation of a made-to-measure package. In this case, the means 10 assign to this future package the minimum calculated dimensions of the logistic unit load in step 701, in other words using the method for determining an arrangement plan according to the embodiments 100, 200, 300 or 400. In a first possible variant, these dimensions are then displayed on a screen or provided by any means to a third party entity which makes the package manually. In a second variant, these dimensions are provided to a robot or other means which will not be described here and which can then autonomously and automatically create the package, which contains, like the other packages, a data structure available to the means 10, which assign this package to the logistic unit load.

As mentioned at the start of the description of this embodiment 700, the description concerned a single logistic unit load. Obviously, the means 10 then repeat the steps for the next logistic unit load on the list of logistic unit loads.

We will now describe a second embodiment 800 of the method for assigning a package to a logistic unit load. As for the embodiment 700, it is implemented once the method for grouping into logistic unit loads has been implemented. It therefore only concerns, as for the embodiment 700, the unit loads for which, at the end of the grouping method 600, no package has been assigned.

As for the embodiment 700, the means consider each of the logistic unit loads one by one. The remaining steps therefore concern the assignment of a package to a determined logistic unit load.

Unlike the embodiment 700, in this embodiment 800 the method does not start by determining the plan for arranging the products of the logistic unit load, mentioned in step 701.

Thus, in step 801, the means 10 retrieve the package types corresponding to the logistic unit load, as in step 702.

In step 802, the means select only the packages capable of containing the logistic unit load, as in step 703.

In step 804, the means sort the selected packages, in the same way as in step 704, on the basis of the same variants if any. At the end of this step 804, the selected packages are therefore sorted in a list, as at the end of step 704.

In step 805, the means 10 start to scan each of the packages on the list. Unlike the embodiment 700, this scan is not interrupted when a package is considered to be adequate.

Thus, a list containing at least one package undergoes the next steps. The means first choose the package with the highest priority on the list sorted in step 804, and associate it with a margin determined in the same way as in step 705.

In step 806, the means 10 implement, for the logistic unit load, and for the package chosen in step 805, the method for determining an arrangement according to the embodiment 500 described above. In fact, as indicated during the description of this embodiment, it differs from the other embodiments of the method for determining an arrangement in that it provides as input the dimensions of a real container. Thus, when implementing this step 806, the means 10 provide the “real” and possibly “useful” dimensions of the package selected in step 805, and determine, via the genetic algorithm as described above in the context of the method 300, the plan for arranging the products of the logistic unit load in this package.

In step 807, the means 10 check the adequacy between the logistic unit load and the package in the same way as in steps 706 and 707. The result of this check is stored by the means 10.

As mentioned above, the method does not stop here if the adequacy is validated. In fact, steps 805 to 807, and therefore in particular the method for determining an arrangement of the embodiment 500, are repeated for the next packages on the sorted list resulting from step 804, and still for the logistic unit load considered at the start of the method. This method 500 may comprise the steps of the method 200, in other words determining a single arrangement plan for this container, or the steps of the genetic algorithm of the method 300, in other words determining and comparing several arrangement plans to finally choose only one. Step 202 corresponds, on each iteration, to providing the dimensions of the package concerned, so that the maximum dimensions of the container correspond to the package dimensions. Since the packages are chosen beforehand to be capable of containing all the contents of the unit, these maximum dimensions of the container finally depend on the dimensions of the contents to be arranged in this package. The results of step 807 are therefore stored for each of these packages.

The repetition of steps 805 to 807 is interrupted once these steps have been implemented for a predetermined number of packages on the sorted list of packages, this number being configured beforehand by a user of the method. The higher the number, the greater the number of packages “tested” using the arrangement method. These steps can also be interrupted if the list of packages has been fully scanned.

Once these steps have been performed a predetermined number of times, in step 808 the means 10 calculate a void rate for each of the packages whose adequacy has been checked in step 807. As in the remainder of this document, this involves comparing the volume of the container, in this case the package chosen in step 805, with the total volume of the products forming the logistic unit load. Thus, at the end of this step 808, the means associate their respective rate with each logistic unit load-package pair, the logistic unit load always being the same, if the adequacy has been checked.

In step 809, if several packages have been considered to be adequate, the means assign to the logistic unit load the one for which the determined void rate is the lowest.

Step 810 corresponds to step 710: if none of the packages can be assigned to the logistic unit load, the means try to identify a selection of other packages of a possibly different type, to repeat steps 802 and after.

At the end of this embodiment, the method therefore identifies a package that is adequate for the logistic unit load, or does not identify any package.

As mentioned, the description concerned a single logistic unit load. Obviously, the means 10 then repeat the steps for the next logistic unit load on the list of logistic unit loads. Optionally, at the end of this second embodiment 800, if no package has been considered to be adequate, the means 10 provide for the execution of the embodiment 700. Thus, depending on the service level requested by a user, it may be provided that the embodiment 800 is implemented in priority, and that the embodiment 700 is implemented each time no package has been assigned to the logistic unit load by the embodiment 800.

### III. Method for Selecting Packages Optimised According to Logistic Unit Loads

The method for selecting packages aims to identify, for a logistician, either on the basis of previous orders involving logistic unit loads shipped by the logistician, or on the basis of new products never shipped, the package references that are the most appropriate for the products likely to be sent in the future by the logistician. This allows the logistician to anticipate future shipments by having in their stock packages of the most adapted types and dimensions, in order to reduce the void rates generated by the logistic unit loads packed and shipped, and in order to avoid unnecessary storage of packages in the warehouse or an excessively high void rate of the “parcels”. We can speak of a “method for enriching a catalogue of package references”. This method can be implemented independently of the two methods described previously. In fact, without implementing the assignment and arrangement methods described above, a logistician having appropriate packages in the warehouse will generate on average less empty space than with inappropriate packages. However, it is advantageous to implement more than one of the methods described. An order will be understood as comprising a list of at least one ordered product, most often several ordered products.

This method for selecting packages on the basis of logistic unit loads, implemented by the means 10, therefore receives as input at least one list of orders, considered as being based on products that will be shipped in the future by the same logistician. In a first embodiment described below, the method also receives as input a list of specific packages to be tested on these products, in order to select only the most appropriate ones. It could be provided to receive several lists of packages. In a second embodiment described below, it only receives the products and/or orders and deduces from them ideal packages to be acquired, or even made to measure.

It is up to the logistician to configure which orders are provided to the means 10 as input. These may be orders, consisting of products, shipped in the past. In fact, it generally happens that the type of orders shipped in the past is similar to the orders shipped in the future. It is therefore relevant to select the packages according to a history of orders shipped previously. For example, this may be all the orders that the logistician has shipped over a predetermined period, for example over an entire year, or a season, or over a shorter period, for example around Christmas. It may also be only a certain type of order that they have shipped. This method is implemented occasionally or at predetermined intervals by the logistician, for example once a week, or once a month, in order to update the package references identified. However, the logistician can also or as an alternative provide orders of products that have never been shipped, for example new products that they expect to deliver in the future. They then want to anticipate the packages to be held in stocks for these orders.

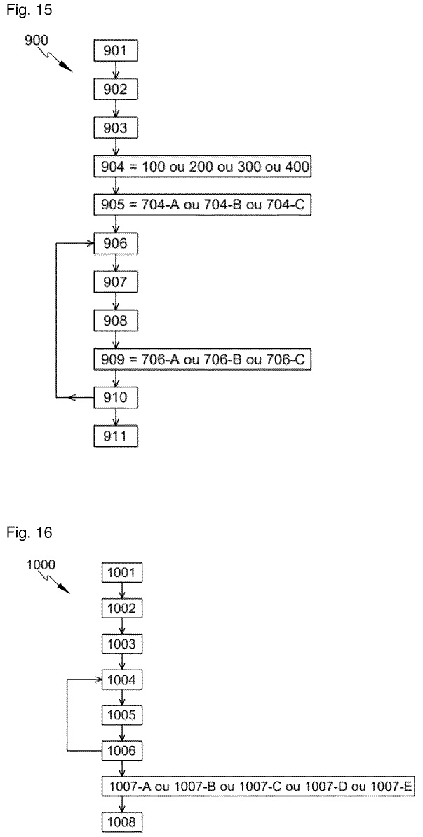

We will first describe, referring to FIG. 15, a first embodiment 900 of a method for selecting packages according to logistic unit loads.

In step 901, in one step, the means 10 obtain a list of products forming the orders shipped previously by the logistician, recorded as a shipping list, each shipment including products to be shipped. These are the orders corresponding to those that the logistician wants to test, to determine which packages would be the most appropriate in the future in case of similar orders. As a variant, the means 10 obtain a list of products forming orders never shipped before by the logistician. These are, for example, new batches of products planned for Christmas. As a variant, the list obtained contains both orders shipped before and orders never shipped. In all cases, the means have the necessary characteristics of the products, such as their dimensions, any additional characteristics: fragile, pre-imposed or not, margin, etc.

In step 902, the means obtain a list of packages. These packages, different from each other, are also provided by the logistician. They correspond to the package references already recorded in database, in other words those available to the logistician in the warehouse or already known to the logistician. The logistician then wants to identify which are the most appropriate references, in terms of dimensions or type, for the products of step 901, among these packages that are already known.

Alternatively, in this step 902, other package references may be provided, which the logistician has not already tested or for which they do not have a real package in stock. These packages “to be tested” come, for example, from package suppliers different from the logistician's usual supplier. In this case, the logistician's objective is to test these new package references on their orders so as to determine whether there are any references more appropriate than the packages they use.

As a variant, they may obviously provide a list comprising both package references they use and new package references to be tested, in order to determine the references they can use to improve their package catalogue and those that can be ignored.

The means 10 scan these products resulting from step 901 and exclude the shipments containing at least one product that no longer exists. In fact, if a product shipped in the past no longer exists, there is no need to perform the next steps for this product.

In step 903, the means 10 group the products of step 901 in logistic unit loads, in order to create a list of logistic unit loads, and possibly determine the package types associated with the latter, using steps similar to those of the method 600 described above. The only difference concerns step 604: to implement the method 900, for the logistic unit loads comprising a “pre-imposed” package, in other words required in a predefined manner by a logistic unit load and thus associated with them in database, the means 10 check whether this package exists among the packages of step 902, and, where applicable, exclude the logistic unit load from the list of logistic unit loads created. In fact, if a logistic unit load requires a specific package that is already known, there is no need to perform the next steps for this logistic unit load since there is no need to find a better package for this logistic unit load.

In step 904, the means scan each of the logistic unit loads on the list of logistic unit loads resulting from step 903 and determine the dimensions of each one. To do this, the means apply to each of these logistic unit loads the method for determining an arrangement plan according to one of the approaches 100, 200, 300 or 400, and assign to each logistic unit load the minimum dimensions of the container determined at the end of one of these approaches.

Alternatively, the means could determine the dimensions of each logistic unit load separately in the context of this method for selecting packages on the basis of logistic unit loads. It is however advantageous for these logistic unit loads to be as compact as possible, in order to select the smallest possible packages, so the arrangement method described above is particularly relevant.

In step 905, the means 10 perform, for the list of packages obtained in step 902, the prioritisation and sorting steps in the same way as in step 704 described above, including any variants described according to the user's choice. Thus, the packages are sorted at least by increasing volume according to variant 704-A, but as an alternative they can be sorted by fictitious volume according to variant 704-B, or according to other criteria, in addition to the real or fictitious volume, according to variant 704-C.

The next steps are performed for each of the packages on this sorted list resulting from step 905. In other words, the means 10 consider in step 906 the package with the highest priority among the sorted list of packages to be tested before moving to the next steps, and the next steps will be repeated for each of these packages, in the order of the sorted list.

In step 907, the means create a local list of logistic unit loads, resulting from the list obtained at the end of step 903, specific to the package chosen in step 906. In particular, if the means 10 have identified, in step 603 of the method 600 implemented in step 903, a particular package type associated with the logistic unit loads, only the logistic unit loads requiring the same package type as that corresponding to the chosen package, or those requiring no particular type, are selected to form this local list of logistic unit loads specific to the chosen package.

In step 908, the means 10 only select from this local list of logistic unit loads resulting from step 907 those whose dimensions are less than or equal to those of the chosen package. Optionally, the means 10 can assign margins, to both the logistic unit load and the package, to perform this step, the margins being preconfigured by default or defined, possibly beforehand, by the user.

In step 909, the means scan the local list of logistic unit loads, resulting from step 908, specific to the package chosen in step 906, and perform, for each of these logistic unit loads, with respect to this package, the adequacy checking steps of step 706, according to its variants 706-A, 706-B or 706-C described above. When a logistic unit load successfully passes this checking step, in other words when it is considered to be adequate for the package, the means 10 assign this logistic unit load to the package, and increment a counter of logistic unit loads assigned to the package.

This step 909 is repeated for each of the logistic unit loads on the local list of logistic unit loads specific to the package chosen in step 906.

In step 910, when the adequacy with the package of each logistic unit load on the local list has been checked, the means determine, via the counter, how many of them have been considered to be adequate for this package. If this number has reached a predetermined threshold, then the package is selected as being part of the packages that must be available in the warehouse for future shipments. This predetermined threshold can be set by the user or by default. It can be configured to depend on the number of packages tested, the number of logistic unit loads or more generally the number of orders tested. It is considered that if the package reaches this number, this proves that it has been considered to be adequate for numerous logistic unit loads, and therefore that it is likely to be adequate for the future logistic unit loads, resulting from future orders. In addition, if this package is thus selected, and only if this is the case, the means 10 remove, from the list of logistic unit loads resulting from step 903, the logistic unit loads that have been assigned to the package selected in step 909. Thus, the adequacy of the other packages will not be checked for these logistic unit loads, to avoid selecting package references which would be redundant. Sorting the package references beforehand ensures that only the packages with the highest priority are selected, therefore in particular those generating the lowest void rate or, in addition and for example, according to the chosen variant of step 704, associated with a particularly relevant durability.

The means thus repeat steps 906 to 910 for each of the packages on the list sorted in step 905 and for as long as there are logistic unit loads to be processed. Consequently, the lower the position of a package on the sorted list, in other words the lower its priority, the fewer the number of logistic unit loads still to be tested, and therefore the less likely it is that the package will be selected, which, as mentioned, increases the probability of selecting priority packages and excluding others. Conversely, if a lower-priority package is selected, this means that there were still numerous logistic unit loads that were not adequate for the previous higher-priority packages, so this selected package is relevant in view of the orders provided as input.

At the end of this embodiment, the logistician therefore has a list of selected packages, forming part of the packages provided in step 902. This list undergoes a step 911 of sending the list to the logistician.

This allows the logistician to acquire and have available selected packages in stock, ready for future shipments to be managed. Selected package obviously refers to “package references”, in other words to a package of specific type and dimensions. The quantity of these packages, for each selected reference, is also data that can be provided by this method since the method has determined the number of logistic unit loads adequate for each package. By extrapolating according to the number and possibly the period concerned by the orders provided as input, the means 10 determine a number of packages to be acquired, over a given period, associated with each selected reference, and also provide this data in this step 911.

As a variant, this list is associated with a calculation report comprising other information relevant for the logistician or any other user of the method. In particular, the means 10 can associate with each selected package reference the number of assignments of logistic unit loads, the package price if it is recorded in databases, as well as the average void rate of each package. For this last data, this is in particular the case if the variant 706-B was implemented when checking the adequacy between the logistic unit load and the package. Alternatively, this void rate can be determined subsequently, for example when creating the calculation report, the means 10 calculating the ratio between the volume of the package and the volume of each logistic unit load considered to be adequate for the package, regardless of the variant implemented in the preceding steps, in order to determine the average void rate between the package and the logistic unit loads assigned to this package.

This list or calculation report can be sent in step 911 by automated means, for example by email. Alternatively, these results can be displayed on a screen available to the user.

As a variant or in addition, the means 10 can automatically order the acquisition of the selected package references, or some of these references based on predetermined criteria, such as the void rate, to store these packages and the number required in the logistician's warehouse ready for future shipments.

We will now describe a second embodiment 1000 of a method for selecting packages on the basis of products and/or orders. It can be implemented as an alternative or in addition to embodiment 900. Its purpose is not to select package references among a list provided to the means 10, unlike the embodiment 900, but to generate directly the most adapted packages according to the products and/or orders provided as inputs.

Thus, in step 1001, the means 10 implement steps 901, 903 and 904 in order to obtain a list of the logistic unit loads on the basis of products provided as input, resulting or not from orders shipped in the past, to determine any associated package types, and to determine their dimensions. Once again, the user chooses which orders are to be provided to the means 10.

For step 903, unlike what has been indicated above, in this case the means do not compare the package types of the logistic unit loads provided with the package types provided, since no package reference is provided in this case. Thus, no logistic unit load is excluded in this case, unlike what is implemented in step 903 of the method 900.

In step 1002, the means 10 group the logistic unit loads on the list by package type, in other words according to package types associated in database with these logistic unit loads in step 1001, in order to form a list of logistic unit loads by package type.

As a variant, this step is not performed. Thus, the packages, with or without an associated type, are not grouped by type. This option is left up to the user. In this case, the rest of these steps only concerns one list: the list of all the packages.

In step 1003, the means consider one of these lists by type, or the single list if step 1002 is not performed. The following steps will therefore be repeated for each of the lists by type resulting from step 1002, in other words the lists of logistic unit loads distributed by package type, or for the single list of packages if no clustering by type has taken place.

In steps 1004 to 1006, for the list considered of logistic unit loads, the means 10 implement a hierarchical clustering algorithm to select various combinations of fictitious package dimensions appropriate for these logistic unit loads. This is described in detail below.

Different hierarchical clustering algorithms are known to those skilled in the art. They allow values to be grouped into clusters, each cluster including values close to each other, the number of clusters being predetermined, set by a user. In the context of this step 1004, an algorithm of this type, which will not be described here, is implemented for each of the dimensions of the logistic unit loads on the list considered. Thus, the means identify the first dimension, the second dimension and the third dimension of each of these logistic unit loads, these dimensions having been determined beforehand in step 1001. To this end, in a first variant of this step, if the user of the method allows the orientation of the logistic unit load to be changed, then the means 10 assign to the first dimension the minimum dimension of the logistic unit load, to the second dimension the intermediate dimension, to the third dimension the maximum dimension of the logistic unit load. In a second variant, if the orientation of the logistic unit load is frozen, the means 10 assign by default the first dimension received in a list of dimensions to the first dimension, the second to the second, the third to the third. Thus, as for the products, the orientation of the logistic unit load can be frozen, for example if one of the products it contains must be kept vertical. As for the products, it can be agreed that the third dimension corresponds to the vertical axis, and the first, second and third dimensions are organised according to this choice. Any other choice is obviously possible. This possibility of freezing or not the orientations can be configured by the user beforehand, globally, or for each logistic unit load.

Then, for all the logistic unit loads on the list considered, the means 10 group each of the values of these dimensions into clusters in each of the dimensions according to the hierarchical clustering algorithm, in other words the means group the values into a predetermined number of value clusters, each cluster containing the values close to each other.

In other words, for the first dimension, the means 10 group the values of each first dimension of each logistic unit load around clusters of this first dimension, the values being grouped around the values provided according to a predetermined number of clusters. The means repeat this clustering step for the second dimension and for the third dimension.

For each of these dimensions, the predetermined number of clusters is set beforehand by default or by the user. Thus, it can be different depending on the dimensions. For example, the values of the first dimensions can be grouped into two clusters, which means that the values of the first dimensions of all the logistic unit loads are grouped around two labels, while for the same logistic unit loads, the values of the second dimensions can be distributed over five clusters, in other words, the values of the second dimensions of all these logistic unit loads are grouped around five labels.

In step 1005, once this has been implemented, the means assign to each cluster of each dimension the highest value of the dimension considered among the logistic unit loads grouped in this cluster. Thus, each cluster of each dimension is associated with a dimension value.

In step 1006, the means perform all the possible combinations between these maximum values of the clusters of the first, second and third dimensions, in order to determine, virtually, packages resulting from all these possible combinations. In other words, for each of the values representing the clusters of the first dimensions, the means associate with them values representing the clusters of the second dimensions and values representing the clusters of the third dimensions, to generate the same number of fictitious packages as there are possible combinations.

Steps 1004 to 1006 are repeated for each of the lists of logistic unit loads resulting from step 1002 if there are several lists, in other words for all the possible package types as they are associated with the logistic unit loads, if grouping by type was carried out in step 1002.

In a step 1007, the means 10 make a selection from these fictitious packages generated in order to identify only the most relevant. Thus, in a first variant 1007-A, this selection is based on sufficiently large dimensions of the package so that a label can be affixed to it. Thus, the packages generated that are too small are excluded. In a variant 1007-B, any other selection criterion based on identified characteristics can be implemented.

In a variant 1007-C, the means 10 consider all, or some, of the logistic unit loads provided as input, in step 1001, and they implement a step of checking the adequacy between a package and a logistic unit load, concerning the adequacy between the dimensions of the package and the dimensions of the logistic unit load, for each of these fictitious packages, to select only the fictitious packages considered to be adequate for a predetermined number of logistic unit loads.

In a variant 1007-D, beforehand and in addition to this variant 1007-C, the means 10 sort these fictitious packages according to step 704-A, or even 704-B or 704-C if they have corresponding characteristics of durability, price or other for these fictitious packages.

Lastly, in another variant 1007-E, the entire embodiment 900 is applied to these fictitious packages to select only some of them. These packages, resulting from this embodiment 1000, or some of these fictitious packages, can thus be tested at the same time as real package references, in the context of the embodiment 900.

The list of packages generated is then sent to the logistician in step 1008, identical to step 911, in other words by email or displayed on a screen.

The logistician then has a list of fictitious packages adapted to their orders since the dimensions calculated come from the dimensions of the logistic unit loads calculated on the basis of the orders previously shipped or that the logistician has identified as likely to be shipped in the future. The logistician can then try to acquire packages corresponding to these determined fictitious packages. This embodiment can therefore be used to generate ideal package references for the orders provided as input. As a variant, the means 10 can try to automatically acquire the packages generated.

In another variant not shown, this embodiment 1000 is only activated in addition to the embodiment 900. In this case, the list of logistic unit loads provided in step 1001 contains only the logistic unit loads for which none of the packages tested in step 909 of the method 900 was considered to be adequate. In other words, these logistic unit loads have no adequate packages among the package references tested, it is therefore highly relevant to apply the embodiment 1000 for these specific logistic unit loads, in order to generate new specific packages for these logistic unit loads. In addition to the adequate nature as provided for in step 909 of the method 900, other criteria could be provided in this variant, such as an individual void rate independent of the void rates described previously, activating for the packages concerned this embodiment 1000 in addition to the embodiment 900.

As an alternative, these embodiments 900 and 1000 can be implemented together in a different way, depending on a choice made by the user for example.

### IV. Method for Preparing a Logistic Unit Load to be Packed

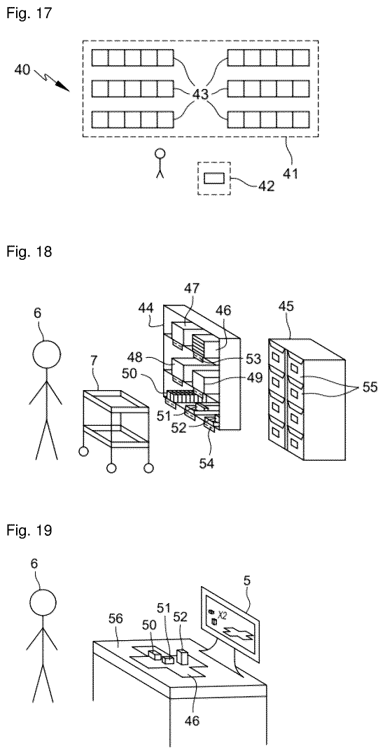

We will now describe, referring to FIGS. 17 to 24, a method for preparing a logistic unit load to be packed, carried out in a warehouse, according to three embodiments. The inputs provided to the method are at least the products forming the logistic unit load. The output of the method is the packed logistic unit load. Unlike most of the steps of the previous methods, implemented by computer, some steps are, in some of the embodiments described below, performed entirely or partly by a human, in particular by the order preparer. The electronically-automated steps are still implemented by the same means 10 as previously, while some steps are performed by other automated means which will be mentioned where applicable.

The first embodiment 1100 is carried out in an installation 40 according to a first embodiment, its top view being schematised on FIG. 17. One part is shown on FIG. 18 and another on FIG. 19. We will first describe this installation.

This installation comprises a space 41 for picking products and packages, also called “picking space”, and an order preparation space 42. “Picking space” designates a space identified as being used to pick objects stored therein, ready for shipment, at known locations, in other words having known positions in the picking space. Thus, each object location, whether the object is a product of an order or a package, is designated by a unique identifier of the picking space 41 in order to find the product or the package using this identifier. A given location can contain in particular identical products or identical packages. This characteristic of identified location distinguishes between a picking space and a mass storage space, in which objects are stored by reference without the possibility of performing a unitary picking operation. Another characteristic which distinguishes between a picking space and a mass storage space is generally the proximity of the picking space 41 with the preparation space 42. Since a collection step, described below, is performed to pick the products and package in the picking space 41 in order to take them to the preparation space 42, it is in fact advantageous for these spaces 41 and 42 to be as close as possible to each other, without hindering either the collection of the products and packages in the picking space 41 or the order preparation in the preparation space 42.

The product and package picking space 41 comprises rows 43 of racks 44 or 45, shown on FIG. 18.

The rack 44 is open, so that products and packages in its locations can be seen. This rack 44 comprises in particular a stack 46 of identical unfolded packages, products 47, 48 and 49 having the shape of rectangular cuboids, and, on the lower level, in plastic recipients, identical products 50, any product 51 and another product 52. Each of the locations is associated with a unique identifier, such as the identifiers 53 and 54. This identifier includes a series of alphanumeric characters used to find, for each of these products, the corresponding row 43 in the space 41, the rack 44 of this row 43, the level of this rack 44, and lastly the location of this level, where the product or package required is located.

The rack 45 is another type of rack, closed. It includes drawers 55 that can be opened, each drawer corresponding to a location, once again provided with a unique identifier, and therefore containing products or packages to be collected.

The rows 43 thus contain a series of racks 44 and 45. As a variant, these could be only racks 44 or only racks 45. As a variant, other types of picking location are possible and are well known to those skilled in the art. These could be any shelves or automated booths providing access to the contents of the locations when instructed by a computer.

The preparation space 42 is shown on FIG. 19. It comprises an order preparation table 56, FIG. 19 showing products 50, 51 and 52 taken from the rack 44 and a cardboard box 46 taken from the same rack 44. The space also includes a screen 5 corresponding to the interaction means already described. Obviously, this screen is connected to the computer means 10 not shown here.

Although only one preparation space has been shown for a picking space, it is generally preferable to have several preparation spaces for one picking space. Obviously, the number of preparation spaces can vary.

The installation 40 also provides for means for collecting the products and packages, using the trolley 7, and, using the computer means 10, modules, or “computer modules”, for selecting the products, the means 10 providing the products forming a logistic unit load, for selecting a package, the means 10 allowing the user to select a package among the packages in the space 41, or automatically providing the adequate package to the user, as described below, and a module for obtaining a collection route for collecting the products and the package, the means 10 providing an optimised route of the locations in the space 41.

“Module” or “computer module” designates a part of a computer program to which one or more predefined functions are assigned. Thus, this installation 40 comprises, in a manner not shown, the medium 2 and the program 3 including these modules, in other words generally the means 10.

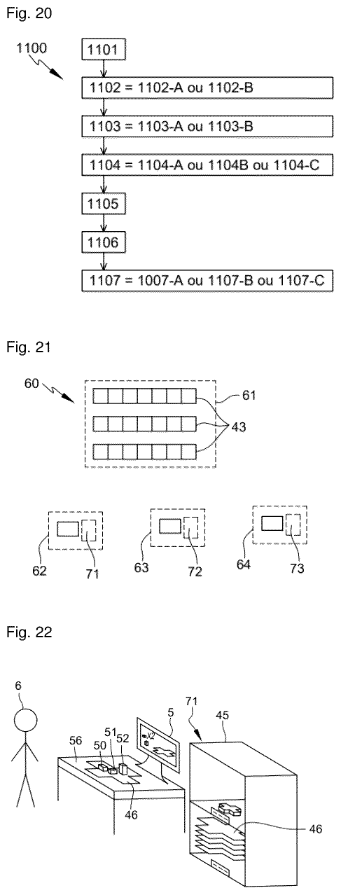

We will now describe the embodiment 1100 performed using this installation 40, referring to these FIGS. 17 to 19 and to FIG. 20.

In a step 1101, products are stored in the picking space 40, in other words in the racks 44 or 45 of the rows 43. These products are those intended to form the logistic unit loads. The products are taken to stocks and stored in the locations by human means or by users using robot-controlled tools. During this step 1101, the means 10 associate, in database, each product in stock with its location identifier in the racks 44 and 45. Thus, each product has an identifier enabling the product to be easily found in the space 41. The way in which the products are chosen to form the stocks is not the subject of this application.

In step 1102, the packages are stored in the picking space 41, in other words once again in the racks 44 or 45 of the rows 43. During this step 1102, the means 10 associate, in database, each package in stock with its location identifier in the racks 44 and 45. Thus, each package has an identifier enabling the product to be easily found in the space 41.

Thus, each product, and each package, has an identifier enabling the product or respectively the package to be easily found in the space 41. In a manner not shown, the space 41 is separated into two sub-spaces, including racks 44 and 45 containing either only products, or only packages. A product picking space, including product locations, and a package picking space, including package locations, are therefore obtained. As a variant not shown, the racks 44 and 45 can contain both products and packages. The space 41 is therefore in this case both a product picking space and a package picking space, including both product locations and package locations.

The way in which the packages are chosen to form the stocks, in a first variant 1102-A, is based on the logistician's practice and experience, known to those skilled in the art. In particular, the logistician relies on their usual box manufacturer and the latter's catalogue of package references. In a second variant 1102-B, the user 6 implements beforehand the method 900 or 1000 for selecting optimised packages according to logistic unit loads already shipped in the past or to be tested, described above, according to one of their embodiments 900 and 1000. The means 10 therefore select the packages to be stored in the picking space 41, on the basis of this method 900 or 1000. It is thus particularly advantageous that only packages appropriate for the logistic unit loads packed in the past in this installation 40 are stored in the picking space 41 for the logistic unit loads to be shipped in the future, since it is likely that these packages are appropriate for these future logistic unit loads to be packed, in particular regarding the dimensions and therefore the void rate of the packed logistic unit loads.

In step 1103, the user 6, in front of their preparation table and therefore in front of their screen 5, as shown on FIG. 19, obtains from the means 10 a selection of products, the selected products forming a logistic unit load to be packed. These are therefore products corresponding to an order and grouped together to form a logistic unit load. In a first variant 1103-A, this grouping is carried out beforehand by any means known to those skilled in the art, in particular by simply grouping together all the products of the same order, or by automated choices not described here. In a second variant 1103-B, the grouping is carried out beforehand by the means 10 according to the method 600 for grouping products into a logistic unit load described above. It is in fact advantageous for the products to be grouped together according to appropriate requirements according to the method 600. The user receives the selection of products via the screen 5, or via a picking slip or picking ticket.

In step 1104, the user receives, in parallel with step 1103, or immediately after, the selection of a package, the package being intended to pack the logistic unit load formed by the products of step 1103. In a first variant 1104-A, it is the user 6 themselves who chooses the package they consider to be appropriate among all the packages available in the picking space 41, for this logistic unit load. They can in particular rely on the dimensions of the logistic unit load, if these are known, to choose a package whose dimensions are slightly greater, by looking, using the means 10, in particular using the interaction means such as the screen 5, for the adequate package. In a second variant 1104-B, this step 1104 is performed by the means 10 according to the method for assigning a package to a logistic unit load, according to one of the embodiments 700 or 800. In this case, the packages provided as inputs to these embodiments 700 and 800 are those available in the picking space 41. It is in fact particularly advantageous for the means 10 to select the adequate package in this way since this generates less empty space by choosing the most appropriate package for the logistic unit load. In addition, by automating this selection, the order preparer does not have to choose a package. The time taken by the subsequent step of collecting the package in the picking space is therefore offset by selecting this package quickly and automatically. More precisely, as described in the context of these methods, the means choose the package that is most appropriate for the logistic unit loads. The selected package is indicated to the user 6 on the screen 5, or as an indication in the picking slip. In a third variant 1104-C, if no package has been selected, for example if no appropriate package is available at the end of the method 700, and as described in step 711, the means 10 display to the order preparer the ideal dimensions of the package suitable for the logistic unit load, so that the preparer can look for a package that is available but not recorded in database, or place an order for the appropriate package. Alternatively, the means 10 transmit the ideal dimensions to a robot that manufactures the package in an automated manner. The package received or manufactured can be placed in the picking space, so that the next steps are implemented in the same way, or taken by other means to the preparation table without undergoing the steps of obtaining a route and of collecting.

In step 1105, the user 6 obtains a route for collecting the selected products and the selected package in the picking space 41, in other words in the package picking space and in the product picking space, the route comprising the identifiers of the locations of the selected products and package to be collected. Thus, the means 10 provide to the user, via the screen 5 or on the “picking slip”, the identifiers of the locations of the selected products, and the identifier of the location of the selected package, and they also determine a route for collecting the products and the package. The route is optimised so that the collection by the user 6, in the space 41, in particular their path along the rows 43, is as fast as possible. Thus, the path from the preparation table 56 to the correct locations of the racks 44 and 45, then the return to the preparation table 56, must be as short as possible. It is therefore the order of the products and package to be picked that is important, and which is optimised. The different ways in which this route is optimised, according to the positions of the locations in the picking space 41, are known to those skilled in the art and are not the subject of this application. These techniques are based on the positions of the product locations. In this case a package is added to these products, which does not modify these techniques since the package is stored, in the same way as a product, in a picking space, with a unique identifier.

In step 1106, the user 6 collects these selected products and package, in the picking space 41, in the order provided by the optimised route determined by the means 10. To collect the products and the package, the user 6 uses the trolley 7, called the “picking trolley”. As a variant, it is not the order preparer who goes to collect the products and package but another person, whose role is to collect the products and package to take them to the preparation space 42 where the order preparer remains.

Other means of collection than a trolley are obviously possible as a variant. These could be, for example, warehouse transport vehicles, forklifts, exoskeletons, robots, etc.

In step 1107, in the preparation space 42, in other words at the table 56, the user 6 arranges the selected products in the selected package, to form the packed logistic unit load. In the example shown on FIG. 19, the user 6 has products 50, 51 and 52 taken from the rack 44 of FIG. 18, and a package 46 taken from the same rack. They were collected in step 1106. In a first variant 1107-A, the user 6 arranges the products in the package according to their own experience and practice, within a given time limit. A second variant 1107-B corresponds to the case where the variant 1104-B was implemented in step 1104, in other words when the method for assigning a package to a logistic unit load according to one of the embodiments 700 and 800 was implemented to select the package. If embodiment 700 was implemented, and that on this occasion, an arrangement plan was determined using one of the embodiments of the arrangement plans 100 to 400, then this plan is reused in this step 1107-B to be provided to the order preparer when arranging the products in the package. If embodiment 800 was implemented for the method for assigning a package, then it is the embodiment 500 which was implemented for the arrangement plan, and the plan corresponding to the chosen package is made available to the order preparer.

According to a third variant 1107-C, no arrangement plan according to one of the embodiments 100 to 500 was implemented previously. The means 10 then implement the method for determining an arrangement plan according to the embodiment 500, by providing as input the dimensions of the package selected in step 1104, in order to determine the adequate arrangement of the products for this package.

At the end of this step 1107, the products forming the logistic unit load are packed in the chosen package. This packed logistic unit load can then undergo the next delivery steps known to those skilled in the art, in particular the affixing of a delivery label, its loading and its shipping. In a variant not shown, the installation includes a space for picking products only and a space for picking packages only. Thus, the route obtained by the means 10 includes two sub-routes: a route optimised only for the products to be collected in the product picking space, which does not include collecting the package, and the route to the selected package, this route only including the package location. This variant is adapted to the case where the product picking space is particularly far away from the package picking space. The user travels the two routes and then goes to the order preparation table to prepare the logistic unit load to be packed.

In another variant not shown, not only the products and the package of a single logistic unit load to be packed are collected, but the products forming several logistic unit loads and the package selected to pack these logistic unit loads are collected simultaneously. Thus, beforehand, the user obtains a route to collect in an optimised manner all the selected products forming the logistic unit loads to be packed, and to collect in an optimised manner all the corresponding packages. The route is either a single route optimised for collecting the products and the packages in the same product and package picking space, or a first route optimised for collecting the products in a product picking space and a second route optimised for collecting the packages in a package picking space. Then, once all the products and packages have been collected, the user can prepare the various logistic unit loads to be packed on the same preparation space, or the collection means travel through several preparation spaces to deposit the products and packages forming each logistic unit load to be prepared. This variant therefore saves a considerable amount of time by optimising the collection of products and packages intended for different logistic unit loads.

We will now describe a second embodiment 1200 of the method for preparing a logistic unit load to be packed, referring to FIGS. 21 to 23. This embodiment is implemented in an installation 60, according to a second embodiment, shown on FIG. 21. It differs from the installation 40 of FIG. 17 in that the product picking space 61 is separate from the package picking spaces 71, 72 and 73. The latter are in fact integrated in the preparation spaces 62, 63 and 64, which are separate from each other. Thus, the packages stored in the picking space 41 of FIG. 19, are in this case stored in the picking spaces 71, 72, and 73, respectively in the order preparation spaces 62, 63 and 64.

The space 71 is shown on FIG. 22. The preparation table is identical to the preparation table 56 of FIG. 19, but it is associated with a rack 45 comprising two locations, associated with their respective identifiers, in which packages, unfolded ready for use, can be seen by transparency. Unlike the racks 44 and 45 of the installation 40, the package picking spaces, such as the rack 45 of FIG. 19, of the installation 60, only comprise packages, and above all, they comprise packages of the same type. Thus, the space 71, provided with racks, only includes packages of a first type. The space 72 only includes packages of another type, the space 73 includes packages of a third type. Note that a type corresponds to a given structure, a given material or a given level of robustness of a package. For example, the space 71 can be dedicated to plastic bags, the space 72 to single-corrugated boxes, the space 73 to double-corrugated boxes. Obviously, the number of preparation spaces in this installation 60 can vary.

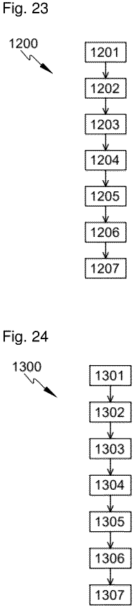

We will now describe, referring to these FIGS. 21 and 22 and to FIG. 23, the steps of the embodiment 1200, emphasising their differences compared with the steps of the embodiment 1100.

Step 1201 is the same as step 1101, the products being stored in the product picking space 61.

Step 1202 is identical to step 1102, except that the packages are not stored in the space 61, but in the spaces 71, 72, and 73, integrated in the respective preparation spaces 62, 63, and 64, by package type. Thus, in a manner not described, it is planned to distribute the packages by package type in the spaces 71, 72, and 73, the means 10 associating, as in step 1102, the identifiers of the locations with each package.

Steps 1203 and 1204 are identical to steps 1103 and 1104, respectively.

In step 1205, the user obtains a route for collecting the selected products, but the route does not include collecting the package in this space, since the package is already available in the package picking space integrated in the preparation space, as shown on FIG. 22. However, the user receives the identifier of the package location in rack 45 of this package picking space, in order to collect this package.

In step 1206, the user 6 only collects the products in the product picking space 61, to take them to the preparation table of the space 62, 63 or 64, and collects the package, beforehand or afterwards, very simply since it is available in its preparation space, in its rack 45. This embodiment therefore removes the need to collect a package in a space separate from the preparation space. It therefore saves time compared with the previous embodiment.

Arrangement step 1207 is identical to step 1107.

Having several order preparation spaces, each one being associated with a package type, for a product picking space increases the order preparation productivity while preserving the gains on the void rate.

As a variant, in addition to grouping packages by package type in the picking spaces integrated in the preparation spaces, these spaces could store some package references rather than others. For example, such an integrated picking space can be configured to store the five most frequently used package references of a predetermined package type.

This embodiment 1200 can be combined with the embodiment 1100, in other words by having packages stored both in a package picking space separate from the preparation space and other packages stored in the picking space integrated in the preparation space. Thus, for multiple orders, the same route can comprise the collection of packages in a separate picking space and the entry of packages in a space integrated in the preparation space. This is particularly relevant if the most frequently used packages are stored in the picking space integrated in the preparation space while the less frequently used packages remain stored in a separate picking space.

In a third embodiment 1300, shown on FIG. 24, the steps are similar to those of the method 1100 or the method 1200, but they are fully automated.

Thus, the steps 1301 and 1302 for storing, in the product picking and package picking spaces, are performed by autonomous vehicles, provided with automated means for positioning in the locations.

Steps 1304 and 1305 are automatically implemented by the modules of the means 10, as described in the embodiments 1100 and 1200.

The collection step 1306 is also automated, an autonomous vehicle automatically collecting the products and, in the case of embodiment 1100, the package. As a variant, the racks forming these picking spaces are automated so that they can move autonomously.

The arrangement step 1307 is performed automatically by robot-controlled arms, according to an arrangement plan determined according to one of the embodiments described above.

Thus, the entire method for preparing a logistic unit load to be packed can be automated.

As a variant, only some of the steps of the method 1300 are automated, others remaining the responsibility of the user.

The invention is not limited to the embodiments described and other embodiments will be clearly apparent to those skilled in the art.

In particular, the embodiments can be combined, whether this is explicitly written or clearly apparent to those skilled in the art.

In all the steps of comparing dimensions, in particular between one or more contents firstly and a container secondly, the means can assign margins that are predetermined or chosen by a user.

1. A method for determining an arrangement plan for arranging several contents in a container, the contents and the container having respective virtual shapes of a rectangular cuboid, the method being implemented by computer and comprising steps of:
prior to a virtual arrangement, determining maximum dimensions of the container according to the dimensions of the contents to be arranged;
among the contents to be arranged in the container, virtually arranging a first content at a predetermined position of the container;
in order to virtually arrange one of the remaining contents in the container:
determining the dimensions and coordinates of several remaining empty spaces of the container, separate from each other and having respective virtual shapes of a rectangular cuboid;
determining possible positions of the remaining content in each empty space;
determining respective distances between a predetermined top of the container and the respective tops of the remaining content in each possible position;
depending on the distances determined, selecting one of the possible positions as virtual arrangement of the remaining content in the container;
repeating the previous arrangement steps for successively each of the other contents still to be virtually arranged in the container, in order to determine an arrangement plan for arranging all the contents in the container.

2. The method according to claim 1, further comprising a step of determining the coordinates of each of the contents arranged virtually in the container, the determined arrangement plan indicating these the coordinates.

3. The method according to claim 1, wherein each content and the container having a first dimension, a second dimension orthogonal to the first dimension and a third dimension orthogonal to the first and second dimensions, the step of determining the maximum dimensions of the container is implemented as follows:
identifying a most voluminous content among the contents to be arranged in the container;
determining a value to be added corresponding to a sum of the maximum dimensions of each content except the most voluminous content;
determining a first maximum dimension of the container corresponding to the sum of a first dimension of the most voluminous content and the value to be added;
determining a second maximum dimension of the container corresponding to the sum of a second dimension of the most voluminous content and the value to be added;
determining a third maximum dimension of the container corresponding to the sum of a third dimension of the most voluminous content and the value to be added.

4. The method according to claim 1, wherein the contents correspond to products forming a single logistic unit load and the container corresponds to a package intended for packing this logistic unit load.

5. The method according to claim 1, wherein:
the contents correspond to packages and the container corresponds to a pallet, a container or a lorry; or
the contents correspond to pallets and the container corresponds to a container or a lorry.

6. The method according to claim 1, wherein the determined arrangement plan also indicates orientations of the contents in the container, these orientations being determined as follows:
for the contents still to be arranged:
the step of determining the possible positions of the content is implemented, in at least one of the empty spaces, for at least two of the possible orientations of the content in the empty space,
the distance separating the top of the container from the tops of the possible positions is determined for these possible orientations, so that selecting the position as a virtual arrangement of the content includes selecting the orientation of this content;
for the first content to be placed, at a predetermined position of the container:
determining possible ways of positioning the content at this position for at least two of the possible orientations of the content,
determining distances separating the predetermined top of the container from the tops of the possible positions of the content for these possible orientations,
selecting the orientation of the content according to the determined distances.

7. The method according to claim 1, comprising, beforehand, a step of sorting the contents to be arranged:
by decreasing volume, so that the first virtually placed content has a largest volume among all the contents to be arranged and the contents still to be virtually arranged are arranged successively according to the sorting, or
according to a characteristic associated with each content different from the volume, the characteristic being one of weight, fragility, radioactivity level, or perishability, or
according to a value resulting from a combination of the volume of the contents and one or more characteristics among the characteristics different from the volume.

8. The method according to claim 1, comprising the following steps:
first, assigning a respective random key to each content to be arranged, the keys determining the order in which the contents are to be arranged;
determining an arrangement plan for arranging the contents according to claim 1, in the determined order;
for these same contents, implementing at least one repetition of the steps of assigning keys and determining a plan, in order to obtain several possible arrangement plans for arranging the contents in the container, each possible arrangement being different from at least some of the other possible arrangements in that the order of the contents virtually arranged in the container is different, these several possible arrangements forming an initial generation of arrangements;
determining a void rate for each arrangement of the initial generation;
selecting a predetermined number of arrangements of the initial generation having a void rate lower than that of other arrangements of the same generation;
crossing over the selected arrangements of the initial generation, the crossover being performed according to the random keys, so as to produce arrangements of a next generation resulting from this crossover;
repeating the steps of determining the void rate, of selecting and of crossing over, at least for this next generation, until a predetermined number of generations is reached;
selecting the arrangement, among all the arrangements of all the generations, having a lowest void rate, to determine the arrangement plan for arranging the contents in the container.

9. The method according to claim 8, wherein, for each generation, before the steps of determining the void rate for each arrangement, the method comprises steps of checking an adequacy of each arrangement with respect to at least one predetermined criterion, for example relating to a weight, fragility, perishability or radioactivity level of the contents of the arrangement, the steps of determining the void rate being performed only for the arrangements checked as being adequate, it being no longer possible to select the other arrangements.

10. The method according to claim 1, comprising the following steps:
implementing the steps according to claim 1 to determine an initial arrangement plan for arranging the contents;
determining a first minimum volume of a first container of the first arrangement plan;
determining a second minimum volume of a second container of a second arrangement plan for the same contents as follows:
each content and the second container having a first dimension, a second dimension orthogonal to the first dimension and a third dimension orthogonal to the first and second dimensions, the first dimension of the second container corresponds to a sum of the first dimensions of each content, the second dimension of this second container corresponds to the largest dimension among the second dimensions of the contents, and the third dimension of this second container corresponds to a largest dimension among the third dimensions of the contents;
determining the minimum volume of the second container on a basis of the determined dimensions of the second container;
determining the arrangement plan, among the first and second arrangement plans, whose container has a smallest minimum volume.

11. The method according to claim 1, comprising, once all the contents have been virtually arranged in the container, a step of determining minimum dimensions of the container including all the virtually arranged contents, the arrangement plan indicating these minimum dimensions.

12. The method according to claim 11, wherein, once the arrangement plan has been determined, a real container is chosen whose dimensions are greater than or equal to the minimum dimensions of the container of the determined arrangement plan, and real contents are arranged in the real container according to the arrangement plan.

13. The method according to claim 8, comprising the following steps:
providing the dimensions of the container in which the contents are to be virtually arranged;
implementing the steps of claim 8 for this container, in order to determine the arrangement plan for arranging the contents in this container.

14. The method according to claim 13, further comprising the following steps:
the container being a first container, determining the void rate of the first container comprising the virtually arranged contents;
providing the dimensions of a second container in which the same contents are to be virtually arranged;
determining a second arrangement plan for arranging the contents in this second container;
determining the void rate of the second container comprising the virtually arranged contents;
choosing the container, among the first and second containers, having the lower void rate, the arrangement plan indicating the container selected;
arranging real contents in a real container chosen according to the arrangement plan.

15. A method for preparing a logistic unit load to be packed, comprising the steps of:
storing products in a product picking space, the space including product locations, each product location being associated with an identifier;
storing packages in a package picking space, the space including package locations, each package location being associated with an identifier;
obtaining a selection of products, the selected products forming a logistic unit load to be packed;
obtaining a selection of a package;
obtaining a route for collecting the selected products and the selected package in the picking spaces, the route comprising the identifiers of the locations of the selected products and of the package to be collected;
collecting the selected products and the selected package in the picking spaces according to the routes and the selections;
in a space for preparing a logistic unit load to be packed, arranging, according to an arrangement plan determined according to claim 1, the selected products in the selected package, in order to form the packed logistic unit load.

16. A computer program, comprising instructions which, when the program is executed by a computer, instruct the computer to implement the steps of the method for determining an arrangement plan according to claim 1.

17. Computer readable-A non-transitory computer-readable storage medium (2) comprising instructions which, when they are executed by a computer, instruct the computer to implement the steps of the method for determining an arrangement plan according to claim 1.

18. A computer program, comprising instructions which, when the program is executed by a computer, instruct the computer to implement the steps of the method for preparing a logistic unit load to be packed according to claim 15.

19. A non-transitory computer-readable storage medium comprising instructions which, when they are executed by a computer, instruct the computer to implement the steps of the method for assigning a package to a logistic unit load according to claim 15.
